(19) United States
(12) Patent Application Publication
(10) Pub. No.: US 2021/0355412 A1
(43) Pub. Date: Nov. 18, 2021

(54) HYDROPHILIZATION TREATMENT AGENT COMPOSITION

(71) Applicant: KAO CORPORATION, Tokyo (JP)

(72) Inventors: Takanori SAITO, Tokyo (JP); Hiroko KAWAGUCHI, Tokyo (JP); Takayuki NOMURA, Tokyo (JP); Haruna SHIMIZU, Wakayama-shi, Wakayama (JP); Kana ITO, Wakayama-shi, Wakayama (JP)

(73) Assignee: KAO CORPORATION, Tokyo (JP)

(21) Appl. No.: 17/286,833

(22) PCT Filed: Nov. 20, 2019
(86) PCT No.: PCT/JP2019/045444

§ 371 Date: Apr. 20, 2021

(30) Foreign Application Priority Data
Nov. 22, 2018 (JP) 2018-219645
Feb. 13, 2019 (JP) 2019-023593

(51) Int. Cl. C11D 1/22; C11D 1/14; C11D 1/12; C11D 3/00; C11D 3/04; C11D 11/00

(52) U.S. Cl. CPC C11D 1/22; C11D 1/143; C11D 11/0023; C11D 3/0036; C11D 3/046; C11D 1/123

(57) ABSTRACT

The present invention is a hydrophilization treatment agent composition containing (A) a branched-type anionic surfactant, (B) a polyvalent metal ion, and water, wherein a molar ratio between (A) and (B), (B)/(A), is 0.01 or more and 10 or less.

### FIELD OF THE INVENTION

The present invention relates to a hydrophilization treatment agent composition and a method for hydrophilizing a solid surface.

### BACKGROUND OF THE INVENTION

Conventionally, as methods for imparting antisoiling properties or decontaminating properties to solid surfaces, relatively distinct methods have been known: water repellent treatment and hydrophilization treatment.

Water repellent treatment is a technique of performing surface treatment for making a solid surface such as glass, metal, fiber or the like water repellant to prevent dirt contained in water from adhering thereto. For example, it is widely practiced to treat clothes with a fabric softener after washing, to spray water repellent on ski wear or the like to render it waterproof, or to wax the painted surface of automobiles.

However, it is difficult to make the surfaces completely water repellent by the water repellent treatments and the repeated contact of the solid surfaces with water causes dirt contained in the water to accumulate thereon, so that an antisoiling effect is difficult to fully develop, and reduction in a decontaminating effect, which results in the adhered dirt becoming harder to remove, may also occur.

On the other hand, if the solid surfaces are subjected to hydrophilization treatment, that is, the treatment of decreasing the contact angle of the solid surfaces relative to water to make the solid surfaces easy to get wet with water, dirt adhering to the solid surfaces after the said treatment becomes easier to remove when washed, or a recontamination prevention effect against dirt can be expected, and in addition, the followings can be expected: an anti-fogging effect on glass, mirrors or the like; an antistatic effect; frost prevention on aluminum fins of heat exchangers; and imparting antisoiling properties, decontaminating properties or the like to the surface of a bathtub, a toilet or the like.

As treatment agents and methods for hydrophilizing solid surfaces, several proposals have been made.

For example, JP-A 2001-181601 discloses an aqueous antisoiling composition containing an amphoteric polyelectrolyte. JP-A 2006-514150 discloses a cleaning or rinsing composition containing a surfactant and a specific polybetaine. JP-A 2012-25820 discloses a hydrophilization treatment agent composition containing an acrylic resin obtained by copolymerizing a polymerizable unsaturated monomer having a specific betaine structure and a specific polymerizable unsaturated monomer, hydrophilic crosslinked polymer particles and a crosslinking agent. JP-A 2009-545642 discloses a method for improving the wettability/hydrophilicity of a hydrophobic substrate including the step of applying a composition including an amphiphilic block copolymer to the substrate, wherein the amphiphilic block copolymer contains a hydrophilic block with a specific structure and a hydrophobic block formed of an ethylenic unsaturated hydrophobic monomer. JP-A 2015-105313 discloses a hydrophilization treatment agent composed of a block polymer A having a polymer segment A-1 derived from an unsaturated monomer including a repeating unit derived from a hydrophobic unsaturated monomer and a polymer segment A-2 derived from an unsaturated monomer including a repeating unit derived from an unsaturated monomer having a sulfobetaine group, wherein the content of the polymer segment A-1 is 0.05 mass % or more and 75 mass % or less. JP-A 2017-190381 discloses a surface treatment agent composed of a copolymer including a specific constituting unit (A) having a betaine group and a specific constituting unit (B) having a cationic group.

In addition, WO-A 2019/102823 discloses a hydrophilization treatment agent composed of a copolymer including a polymer segment A-1 having a betaine group and a polymer segment A-2 having an aromatic group. Moreover, it states that surfactants are used to improve the hydrophilization performance of solid surfaces when oily stain substances adhere thereto. JP-A 2001-504227 relates to a membrane composed of polymers suitable for use in immunodiagnostic assays and blotting assays, and methods of preparing and using the same. This literature discloses a monodentate sulfonate surfactant and/or an α-olefin sulfonate surfactant as preferable hydrophilic compounds, and Bioterge AS-40 prepared by Stepan Co. as the most preferable surfactant. WO-A 2002-102907 discloses a coating composition including a sulfonic acid salt. It states that the sulfonic acid salt is selectively used since it is excellent in permeability into the resultant coating film and in wetting property. WO-A 2019/013322 discloses a method for washing a hard article, the method including a contact step of bringing a detergent liquid obtained by mixing (a) a potassium internal olefin sulfonate and (b) water having a hardness of 5° dH or more into contact with the hard article, and a step of rinsing the hard article after the contact step with water having a hardness of 5° dH or more, wherein the detergent liquid at 30° C. or more is brought into contact with the hard article at least in a part of the contact step.

### SUMMARY OF THE INVENTION

The present invention provides a hydrophilization treatment agent composition and a method for hydrophilizing solid surfaces, which develop excellent hydrophilizing ability and improve the hydrophilicity of various solid surfaces such as hard surfaces and the like.

In addition, the present invention relates to a hydrophilization detergent composition capable of washing and hydrophilizing solid surfaces, and a hydrophilizing and washing method using the same.

The present invention relates to a hydrophilization treatment agent composition containing (A) a branched-type anionic surfactant, (B) a polyvalent metal ion, and water, wherein a molar ratio between (A) and (B), (B)/(A), is 0.01 or more and 10 or less.

The present invention includes a hydrophilization treatment agent composition containing (A) a branched-type anionic surfactant, (B) a polyvalent metal ion, and water, wherein a molar ratio between (A) and (B), (B)/(A), is 0.2 or more and 10 or less.

In addition, the present invention relates to a method for hydrophilizing a solid surface, wherein a treatment liquid containing (A) a branched-type anionic surfactant, (B) a polyvalent metal ion, and water, in which a molar ratio between (A) and (B), (B)/(A), is 0.01 or more and 10 or less, is brought into contact with the solid surface.

The present invention includes a method for hydrophilizing a solid surface, wherein a treatment liquid containing (A) a branched-type anionic surfactant, (B) a polyvalent metal ion, and water, in which a molar ratio between (A) and (B), (B)/(A), is 0.2 or more and 10 or less, is brought into contact with the solid surface.

Moreover, the present invention relates to a hydrophilization detergent composition containing (A1) an internal olefin sulfonate salt [hereinafter, referred to as component (A1)].

Further, the present invention relates to a hydrophilization detergent composition containing component (A1), (B) a polyvalent metal ion, and water, wherein component (A1) is contained in an amount of 0.03 mass % or more.

Furthermore, the present invention relates to a method for hydrophilizing and washing a solid surface including the following step 1:

### <Step 1>

a step of bringing hydrophilization detergent liquid (I) containing (A1) an internal olefin sulfonate salt in an amount of 0.03 mass % or more into contact with the solid surface.

Furthermore, the present invention relates to a hydrophilization detergent composed of (A1) an internal olefin sulfonate salt and water.

Furthermore, the present invention relates to use of the aforementioned compositions of the present invention for hydrophilizing a solid surface.

Hereinafter, (A) a branched-type anionic surfactant is referred to as component (A), and (B) a polyvalent metal ion as component (B) to make an explanation.

According to the present invention, provided are a hydrophilization treatment agent composition and a method for hydrophilizing solid surfaces capable of imparting excellent hydrophilicity to solid surfaces.

According to the present invention, provided are a hydrophilization detergent composition and a hydrophilizing and washing method using the same capable of washing and hydrophilizing solid surfaces.

### BRIEF DESCRIPTION OF THE DRAWINGS

FIG. 1 shows a photograph of the condition of stainless steel pieces in the evaluation of a recontamination prevention effect in Examination Example 4.

FIG. 2 shows photographs of the condition of stainless steel pieces in the evaluation of decontaminating properties in Examination Example 5.

FIG. 3 shows photographs of the condition of wine glasses in the evaluation of anti-fogging properties in Examination Example 6.

FIG. 4 shows a photograph of the condition of test boards in evaluation in Examination Example 7.

### EMBODIMENTS OF THE INVENTION

### [Hydrophilization Treatment Agent Composition]

Component (A) is a branched-type anionic surfactant. Branched-type anionic surfactants are anionic surfactants in which hydrocarbon groups, which are hydrophobic parts, have branched structures. Note that, in the present invention, anionic surfactants having hydrocarbon groups whose carbon atoms bonded to anionic groups, which are hydrophilic parts, are secondary or tertiary carbon atoms may also be regarded as anionic surfactants having branched structures.

Examples of component (A) include an anionic surfactant having a branched chain hydrocarbon group with 10 or more and 30 or less carbons.

Examples of component (A) include an anionic surfactant having a branched chain hydrocarbon group with 10 or more and 30 or less carbons and a sulfate group or a sulfonic acid group.

A branched chain hydrocarbon group of component (A) has preferably 10 or more, more preferably 16 or more and further preferably 18 or more, and preferably 30 or less, more preferably 28 or less, further preferably 24 or less and furthermore preferably 22 or less carbons.

Examples of a branched chain hydrocarbon group of component (A) include a branched chain alkyl group, a branched chain alkenyl group and an aryl group having a branched chain alkyl group.

Examples of component (A) include an anionic surfactant represented by the following general formula (A):

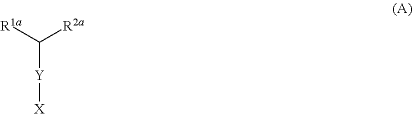

wherein each of R^{1a} and R^{2a} independently represents a hydrocarbon group with 1 or more and 28 or less carbons, which may include a substituent or a linking group; X represents a group selected from SO₃M, COOM and OSO₃M; Y represents a single bond or a phenylene group; and M represents a counter ion.

In the formula (A), examples of a hydrocarbon group of R^{1a} or R^{2a} include an alkyl group, an alkenyl group and an aryl group. An alkyl group or an alkenyl group is preferable.

A hydrocarbon group of R^{1a} or R^{2a} may include a substituent such as a hydroxy group or the like or a linking group such as a COO group or the like.

The total number of carbons in R^{1a} and R^{2a} is preferably 9 or more and 29 or less. Note that the number of carbons in the substituent or linking group is not included in the number of carbons in the hydrocarbon group of R^{1a} or R^{2a}.

In the formula (A), X is preferably SO₃M.

In the formula (A), examples of M include an alkali metal ion, an alkaline earth metal (½ atom) ion, an ammonium ion or an organic ammonium ion. M is preferably an alkali metal ion, more preferably a sodium ion and a potassium ion and further preferably a potassium ion.

Y is preferably a single bond.

Examples of component (A) include one or more branched-type anionic surfactants selected from an internal olefin sulfonate salt (IOS), a linear alkylbenzene sulfonate salt (LAS), a secondary alkane sulfonate salt (SAS) and a dialkyl sulfosuccinate salt (DASS).

Component (A) is preferably an IOS from the viewpoint of improving the hydrophilicity of solid surfaces, for example, hard surfaces. An IOS with 16 or more and further 18 or more, and 24 or less and further 22 or less carbons is preferable. This number of carbons is the number of carbons expressed in terms of an acid-type compound. An exemplary IOS salt is an alkali metal salt, an alkaline earth metal (½ atom) salt, an ammonium salt or an organic ammonium salt. Exemplary alkali metal salts are a sodium salt and a potassium salt. Exemplary alkaline earth metal salts are a calcium salt and a magnesium salt. An exemplary organic ammonium salt is an alkanol ammonium salt with 2 or more and 6 or less carbons. As an IOS salt, an alkali metal salt is preferable and a potassium salt is more preferable.

An IOS of the present invention can be obtained by the sulfonation, neutralization, hydrolysis and the like of an internal olefin with the double bond internal to the olefin chain (at the position 2 or higher). The sulfonation of the internal olefin causes β-sultone to be quantitatively produced, and a part of the β-sultone changes into γ-sultone and olefin sulfonic acid, which further convert into a hydroxy alkane sulfonate salt (H species) and an olefin sulfonate salt (O species) during the neutralization and hydrolysis processes (e.g., J. Am. Oil Chem. Soc. 69, 39 (1992)). The IOS is a mixture of them and mainly a sulfonate salt in which the sulfonic acid group is internal to (at the position 2 or higher of) the carbon chain (a hydroxy alkane chain in the H species or an olefin chain in the O species). The substitution position distribution of the sulfonic acid groups in the carbon chains in the IOS can be quantified by such a method as gas chromatography, nuclear magnetic resonance spectroscopy or the like.

In the IOS, the proportion of an IOS in which the sulfonic acid group is present at the position 2 of the aforementioned carbon chain is preferably 5% or more and more preferably 10% or more, and preferably 45% or less and more preferably 30% or less on a molar or mass basis from the viewpoint of improving the washing performance of the composition of the present invention and the hydrophilicity of hard surfaces.

In the IOS, the proportion of an IOS in which the sulfonic acid group is present at the position 1 of the aforementioned carbon chain is preferably 0.2% or more, more preferably 0.5% or more and further preferably 1.0% or more, and preferably 20% or less, more preferably 10% or less, further preferably 5% or less and furthermore preferably 3% or less on a molar or mass basis from the viewpoint of improving the washing performance of the composition of the present invention and the hydrophilicity of hard surfaces.

The aforementioned carbon chain in the IOS has preferably 10 or more, more preferably 16 or more and further preferably 18 or more, and preferably 30 or less, more preferably 28 or less, further preferably 24 or less and furthermore preferably 22 or less carbons from the viewpoint of improving the washing performance of the composition of the present invention and the hydrophilicity of hard surfaces. That is, the hydrophilization treatment agent composition of the present invention more preferably contains an IOS with 18 or more and 22 or less carbons as component (A).

In the IOS, the proportion of an IOS with 16 or more and 24 or less carbons is preferably 50 mass % or more, more preferably 70 mass % or more, further preferably 80 mass % or more, furthermore preferably 90 mass % or more, furthermore preferably 95 mass % or more and furthermore preferably 97 mass % or more, and preferably 100 mass % or less and may be 100 mass % from the viewpoint of improving the washing performance of the composition of the present invention and the hydrophilicity of hard surfaces.

In the IOS, the molar ratio of the H species to the O species (H species/O species) is preferably more than 50/50 and more preferably more than 70/30, and preferably 95/5 or less and more preferably 90/10 or less from the viewpoint of improving the washing performance of the composition of the present invention and the hydrophilicity of hard surfaces.

The hydrophilization treatment agent composition of the present invention contains component (A) in an amount of preferably 0.001 mass % or more, more preferably 0.005 mass % or more and further preferably 0.01 mass % or more, and preferably 60 mass % or less, more preferably 40 mass % or less, further preferably 25 mass % or less, furthermore preferably 10 mass % or less and furthermore preferably 5 mass % or less from the viewpoint of improving the washing performance of the composition of the present invention and the hydrophilicity of hard surfaces. Note that mass % of component (A) is based on the amount expressed in terms of a compound in which the anionic group is not neutralized, i.e., an acid-type compound (the same applies hereinafter).

Component (B) is a polyvalent metal ion. An exemplary polyvalent metal ion is a divalent or more and trivalent or less metal ion, and a divalent metal ion is preferable.

Component (B) is preferably ions of the group 2 elements and more preferably one or more selected from a calcium (Ca) ion and a magnesium (Mg) ion from the viewpoint of improving the hydrophilicity of solid surfaces under coexistence with component (A). Component (B) preferably includes a Ca ion. Component (B) more preferably includes a Ca ion and an Mg ion. When component (B) includes a Ca ion and an Mg ion, the molar ratio of Ca ion/Mg ion is preferably 5/5 or more and more preferably 7/3 or more, and preferably 9/1 or less.

The present invention includes a hydrophilization treatment agent composition containing (A) a branched-type anionic surfactant [component (A)], (B1) one or more ions selected from a Ca ion and an Mg ion [hereinafter, referred to as component (B1)], and water, wherein a molar ratio between components (A) and (B1), (B1)/(A), is 0.01 or more and 10 or less. All the descriptions herein can also be applied to this hydrophilization treatment agent composition by reading component (B) as component (B1).

The present invention includes a hydrophilization treatment agent composition containing an IOS as component (A1) [hereinafter, referred to as component (A1)], (B1) one or more ions selected from a Ca ion and an Mg ion [hereinafter, referred to as component (B1)], and water, wherein a molar ratio between components (A1) and (B1), (B1)/(A1), is 0.01 or more and 10 or less.

All the descriptions herein can also be applied to these hydrophilization treatment agent compositions by reading component (A) as component (A1) and component (B) as component (B1).

Component (B) may be incorporated into the hydrophilization treatment agent composition of the present invention, for example, by using a water-soluble polyvalent metal salt as a formulation component thereof. In addition, it may be incorporated into the hydrophilization treatment agent composition of the present invention by using water containing a hardness component corresponding to component (B) as a raw material of the composition.

In the hydrophilization treatment agent composition of the present invention, a molar ratio between components (A) and (B), (B)/(A), is 0.01 or more, preferably 0.1 or more, more preferably 0.2 or more, further preferably 0.5 or more and further preferably 1 or more, and 10 or less, preferably 5 or less and more preferably 3 or less from the viewpoint of improving the hydrophilicity of solid surfaces. Note that the number of moles of component (A) in the molar ratio of (B)/(A) is based on the amount expressed in terms of a compound in which the anionic group is not neutralized, i.e., an acid-type compound.

The hydrophilization treatment agent composition of the present invention can contain, in addition to components (A) and (B), an anionic surfactant other than component (A), a nonionic surfactant, an amphoteric surfactant, a solvent, an oil agent or the like as an optional component. Exemplary solvents are butyldiglycol, dipropylene glycol, ethanol and the like. Exemplary oil agents are phenylglycol, benzyl alcohol and the like.

The hydrophilization treatment agent composition of the present invention contains water. Water is usually the balance of a composition and is contained in such an amount as to make the total 100 mass %. The hydrophilization treatment agent composition of the present invention is preferably a liquid composition.

The pH of the hydrophilization treatment agent composition of the present invention at 20° C. is preferably 3 or more, more preferably 4 or more and further preferably 5 or more, and preferably 12 or less, more preferably 10 or less and further preferably 9 or less.

The viscosity of the hydrophilization treatment agent composition of the present invention at 20° C. is preferably 1 mPa·s or more and more preferably 2 mPa·s or more, and preferably 10000 mPa·s or less and more preferably 5000 mPa·s or less. This viscosity can be measured using a B-type viscometer (manufactured by Toki Sangyo Co., Ltd., TVB-10M) with a rotor and rotation speed appropriate for the viscosity. When the viscosity of the composition is so low that it cannot be measured with the B-type viscometer, it can be measured using a rheometer (manufactured by Anton Paar GmbH, Physica MCR301) with a cone plate appropriate for the viscosity.

The hydrophilization treatment agent composition of the present invention can be directed to various solid surfaces such as hard surfaces, fabric surfaces, skin surfaces, hair surfaces and the like. The hydrophilization treatment agent composition of the present invention is preferably for use on hard surfaces. Exemplary hard surfaces are hard surfaces made of such materials as plastic, ceramic, metal, wood, glass, rubber, carbon materials and the like. The hard surfaces may be surfaces of hard articles, e.g., surfaces of hard articles made of the aforementioned materials. Exemplary plastics are acrylic resin, polyamide, polycarbonate, melamine, polyvinyl chloride, polyester, polystyrene, polyethylene, polypropylene, ABS, FRP (fiber reinforced plastic) and the like. Exemplary metals are alloys such as stainless steel and the like, aluminum, and irons such as automotive steel and the like, etc. Exemplary rubbers are natural rubber, diene synthetic rubber and the like. Exemplary woods are woods used for flooring and the like, etc. The woods used for flooring and the like may be the surface-treated. Either woven fabrics or non-woven fabrics may be favorable as fabrics, and woven fabrics are preferable from the viewpoint of the effect of the present invention. Fabrics made of synthetic fibers are preferable. Fabrics made of hydrophobic fibers are preferable. Fabrics used as manufacturing materials for textile products are taken as one example.

Solid surfaces hydrophilized with the hydrophilization treatment agent composition of the present invention and the hydrophilizing method of the present invention may have improved anti-fogging properties, antisoiling properties, decontaminating properties, water absorbency and the like.

The hydrophilization treatment agent composition of the present invention may be an anti-fogging agent composition. That is, the present invention provides an anti-fogging agent composition containing component (A), component (B) and water, wherein a molar ratio between (A) and (B), (B)/(A), is 0.01 or more and 10 or less.

The hydrophilization treatment agent composition of the present invention may be an antisoiling treatment agent composition. That is, the present invention provides an antisoiling treatment agent composition containing component (A), component (B) and water, wherein a molar ratio between (A) and (B), (B)/(A), is 0.01 or more and 10 or less.

The hydrophilization treatment agent composition of the present invention may be a decontaminating treatment agent composition. That is, the present invention provides a decontaminating treatment agent composition containing component (A), component (B) and water, wherein a molar ratio between (A) and (B), (B)/(A), is 0.01 or more and 10 or less.

The hydrophilization treatment agent composition of the present invention may be a water absorbency imparting agent composition. That is, the present invention provides a water absorbency imparting agent composition containing component (A), component (B) and water, wherein a molar ratio between (A) and (B), (B)/(A), is 0.01 or more and 10 or less.

The hydrophilization treatment agent composition of the present invention may be a hydrophilization detergent composition.

That is, the present invention provides a hydrophilization detergent composition containing component (A), component (B) and water, wherein a molar ratio between (A) and (B), (B)/(A), is 0.01 or more and 10 or less.

In addition, the present invention provides a hydrophilization detergent composition containing component (A), component (B1) and water, wherein a molar ratio between components (A) and (B1), (B1)/(A), is 0.01 or more and 10 or less.

Moreover, the present invention provides a hydrophilization detergent composition containing component (A1), component (B1) and water, wherein a molar ratio between components (A1) and (B1), (B1)/(A1), is 0.01 or more and 10 or less.

The matters mentioned in the hydrophilization treatment agent composition of the present invention can be appropriately applied to these compositions. Further, in these compositions, preferable modes, for example, components (A) and (B) and the contents thereof, etc. are also the same as in the hydrophilization treatment agent composition of the present invention.

The present invention provides a method for producing a hydrophilization treatment agent composition, wherein component (A), component (B) and water are mixed in such a manner that a molar ratio between components (A) and (B), (B)/(A), is 0.01 or more and 10 or less. The present invention provides a method for producing a hydrophilization detergent composition, wherein component (A), component (B) and water are mixed in such a manner that a molar ratio between components (A) and (B), (B)/(A), is 0.01 or more and 10 or less.

The present invention provides a method for producing a hydrophilization treatment agent composition, wherein a composition containing component (A) and water is mixed with a composition containing component (B) and water in such a manner that a molar ratio between components (A) and (B), (B)/(A), is 0.01 or more and 10 or less.

The present invention provides a method for producing a hydrophilization detergent composition, wherein a composition containing component (A) and water is mixed with a composition containing component (B) and water in such a manner that a molar ratio between components (A) and (B), (B)/(A), is 0.01 or more and 10 or less.

The present invention provides a method for producing a hydrophilization treatment agent composition, wherein a composition containing component (A) is mixed with water with a hardness of 4° dH or more and 100° dH or less containing component (B) in such a manner that a molar ratio between components (A) and (B), (B)/(A), is 0.01 or more and 10 or less.

Note that hardness (° dH) used herein refers to the concentration of calcium and magnesium in water or a composition expressed as 1 mg/L (ppm)=about 0.056° dH (1° dH=17.8 ppm) in terms of the CaCO₃ equivalent concentration.

A specific method for measuring the hardness of water herein is shown below.

### <Method for Measuring Hardness of Water>

[Reagent]

0.01 mol/l EDTA-2Na solution: 0.01 mol/l aqueous solution of disodium ethylenediaminetetraacetate (solution for titration, 0.01 M EDTA-Na2, manufactured by Sigma-Aldrich Co. LLC (SIGMA-ALDRICH))

Universal BT indicator (product name: Universal BT, manufactured by DOJINDO LABORATORIES)

Ammonia buffer solution for hardness measurement (solution in which 67.5 g of ammonium chloride is dissolved in 570 ml of 28 w/v % ammonia water and whose total amount is made up to 1000 ml with deionized water)

### [Measurement of Hardness]

(1) 20 ml of water as a sample is collected in a conical beaker with a vollpipette.
(2) 2 ml of the ammonia buffer solution for hardness measurement is added.
(3) 0.5 ml of the Universal BT indicator is added. It is checked that the solution after the addition is reddish purple.
(4) While the conical beaker is shaken well, the 0.01 mol/l EDTA.2Na solution is added dropwise from a burette, and the point of time when the sample water turns blue is defined as the end point of the titration.
(5) The total hardness is determined by the following calculation formula:

Hardness (° dH)=T×0.01×F×56.0774×100/A

T: titration amount of 0.01 mol/l EDTA.2Na solution (mL)
A: sample volume (20 mL, volume of sample water)
F: factor of 0.01 mol/l EDTA-2Na solution

The present invention provides a method for producing a hydrophilization detergent composition, wherein a composition containing component (A) is mixed with water with a hardness of 4° dH or more and 100° dH or less containing component (B) in such a manner that a molar ratio between components (A) and (B), (B)/(A), is 0.01 or more and 10 or less.

These producing methods are suitable as methods for producing the hydrophilization treatment agent composition of the present invention.

The matters mentioned in the hydrophilization treatment agent composition of the present invention can be appropriately applied to these producing methods.

The present invention includes use, as a hydrophilization treatment agent, of a composition containing component (A), component (B) and water, wherein a molar ratio between components (A) and (B), (B)/(A), is 0.01 or more and 10 or less. In addition, the present invention includes use, for hydrophilizing a solid surface, of a composition containing component (A), component (B) and water, wherein a molar ratio between components (A) and (B), (B)/(A), is 0.01 or more and 10 or less. The matters mentioned in the hydrophilization treatment agent composition of the present invention can be appropriately applied to these uses. In these uses, preferable modes such as, for example, specific examples or the contents in the compositions of components (A) and (B), or the like are the same as in the hydrophilization treatment agent composition of the present invention.

### [Method for Hydrophilizing Solid Surface]

The present invention provides a method for hydrophilizing a solid surface, wherein a treatment liquid containing component (A), component (B) and water, in which a molar ratio between components (A) and (B), (B)/(A), is 0.01 or more and 10 or less (hereinafter, sometimes also referred to as a treatment liquid of the present invention), is brought into contact with the solid surface. Component (A), component (B) and the solid surface are the same as mentioned in the hydrophilization treatment agent composition of the present invention. The matters mentioned in the hydrophilization treatment agent composition of the present invention can be appropriately applied to the method for hydrophilizing a solid surface of the present invention. For example, in the method for hydrophilizing a solid surface of the present invention, preferable modes such as specific examples or the contents in the treatment liquid of components (A) and (B), or the like are the same as in the hydrophilization treatment agent composition of the present invention (provided that the hydrophilization treatment agent composition is read as the treatment liquid as necessary).

The treatment liquid of the present invention may be the hydrophilization treatment agent composition of the present invention or may be obtained by mixing the hydrophilization treatment agent composition of the present invention with water.

In the method for hydrophilizing a solid surface of the present invention, the solid surface is preferably a solid surface of a hard article.

In the present invention, it has been found that excellent hydrophilicity can be imparted to solid surfaces such as hard surfaces or the like by applying components (A) and (B) to the solid surfaces while allowing them to coexist at a predetermined molar ratio.

Further, in the present invention, it has been found that solid surfaces such as hard surfaces or the like can be washed and excellent hydrophilicity can be imparted thereto by applying components (A) and (B) to the solid surfaces while allowing them to coexist at a predetermined molar ratio.

In the present invention, it is only necessary to create a situation in which components (A) and (B) are applied to a solid surface while allowed to coexist at a predetermined molar ratio in any of the steps of treating the solid surface. For example, after a composition containing component (A), component (B) and water, in which a molar ratio of (B)/(A) is less than 1, is brought into contact with the solid surface, water containing component (B) may be supplied to make (B)/(A) 0.01 or more and 10 or less while component (A) remains on the solid surface or while the above composition containing component (A) is in contact with the solid surface, thereby forming the treatment liquid of the present invention (hereinafter, also referred to as a hydrophilization treatment liquid) and bringing the said treatment liquid into contact with the solid surface.

The hydrophilization treatment liquid of the present invention is a liquid composition containing water, and preferably an aqueous solution or an aqueous dispersion from the viewpoint of stability in handling.

The hydrophilization treatment liquid of the present invention that is brought into contact with the solid surface contains component (A) of the present invention in an amount of preferably 0.001 mass % or more, more preferably 0.005 mass % or more and further preferably 0.01 mass % or more, and preferably 10 mass % or less, more preferably 5 mass % or less and further preferably 3 mass % or less from the viewpoint of improving the hydrophilicity of the solid surface. When the hydrophilization treatment agent composition of the present invention contains component (A) in this range, it can be used as-is as the treatment liquid of the present invention.

In the hydrophilizing method of the present invention, the hydrophilization treatment liquid of the present invention is brought into contact with the solid surface for preferably 0.1 seconds or more, more preferably 0.5 seconds or more, further preferably 1 second or more, further preferably 10 seconds or more and furthermore preferably 60 seconds or more from the viewpoint of improving the hydrophilicity of the solid surface, and preferably 90 minutes or less, more preferably 60 minutes or less and further preferably 30 minutes or less from the viewpoint of improving productivity.

The temperature of the hydrophilization treatment liquid of the present invention that is brought into contact with the solid surface is preferably 5° C. or more, more preferably 10° C. or more and more preferably 15° C. or more, and preferably 95° C. or less, more preferably 90° C. or less, more preferably 80° C. or less from the viewpoint of improving the hydrophilicity of the solid surface and the viewpoint of the easiness of the treatment method. In addition, the said temperature is further preferably 50° C. or less, furthermore preferably 40° C. or less, furthermore preferably 35° C. or less and furthermore preferably 30° C. or less from the viewpoint of reducing environmental burdens.

Moreover, in the hydrophilizing method of the present invention, the treatment liquid of the present invention may be left for 10 seconds or more and 30 minutes or less at 0° C. or more and 80° C. or less after brought into contact with the solid surface.

In the hydrophilizing method of the present invention, the solid surface may be rinsed with water after the hydrophilization treatment liquid of the present invention is brought into contact with the solid surface. The use of the hydrophilization treatment liquid of the present invention maintains a hydrophilizing effect even if the solid surface is rinsed after treated. Therefore, it has a more advantageous effect on objects for which rinsing is desirable. After rinsed, the solid surface can be dried. Water with the same hardness as the water used for preparing the hydrophilization treatment liquid of the present invention is preferably used for rinsing. For example, water with a hardness of 4° dH or more and 100° dH or less can be used for rinsing.

A method for bringing the hydrophilization treatment liquid of the present invention into contact with the solid surface is not particularly limited. Examples thereof include, for example, the following methods (i) to (iii) and the like:

(i) A method of immersing the solid in the hydrophilization treatment liquid of the present invention;
(ii) A method of spraying or applying the hydrophilization treatment liquid of the present invention onto the solid surface; and
(iii) A method of washing the solid surface with the hydrophilization treatment liquid of the present invention in accordance with the usual manner.

In the aforementioned method (i), an immersion time period is preferably 0.5 minutes or more, more preferably 1 minute or more, further preferably 2 minutes or more, further preferably 4 minutes or more, further preferably 8 minutes or more and further preferably 20 minutes or more from the viewpoint of improving the hydrophilicity of the solid surface, and preferably 60 minutes or less and more preferably 50 minutes or less from the viewpoint of improving productivity.

In the aforementioned method (ii), a method for spraying or applying the hydrophilization treatment liquid of the present invention onto the solid surface can be selected as appropriate according to the size (area) of the solid surface or the like. A method of spraying the hydrophilization treatment liquid of the present invention onto the solid surface with a spray or the like and thereafter drying is preferable. As necessary, it may be rinsed with water after sprayed. In addition, it may be spread thinly with a sponge or the like after sprayed.

The amount of the hydrophilization treatment liquid of the present invention to be sprayed or applied onto the solid surface is, for example, preferably 0.01 mL or more and 1 mL or less per 10 cm² in the case of the hydrophilization treatment liquid of the present invention in which the content of component (A) of the present invention is 0.1 mass %.

In the aforementioned method (iii), the hydrophilization treatment liquid of the present invention is preferably used or brought into contact with the solid surface in the form of a detergent composition containing components (A) and (B) of the present invention. In the case of the form of such a detergent composition, the pH is preferably 4 or more, and preferably 10 or less and more preferably 8 or less from the viewpoints of safety in handling and preventing the solid surface from being damaged.

The detergent composition can optionally contain another surfactant or the like.

As mentioned in the above (iii), the present invention is also capable of washing the solid surface. The method for hydrophilizing a solid surface of the present invention may be a method for hydrophilizing and washing a solid surface. That is, the present invention provides a method for hydrophilizing and washing a solid surface, wherein the treatment liquid of the present invention containing component (A), component (B) and water is brought into contact with the solid surface.

The method for hydrophilizing a solid surface of the present invention may include, for example,

preparing a treatment liquid by mixing a composition containing component (A), a composition containing component (B), and water in such a manner that a molar ratio between components (A) and (B), (B)/(A), is 0.01 or more and 10 or less and

bringing the treatment liquid into contact with the solid surface. The water used for preparing the treatment liquid may be contained in the composition containing component (A) and/or the composition containing component (B). The treatment liquid is preferably prepared by mixing a composition containing component (A) and water with a composition containing component (B) and water. In addition, this method may optionally include rinsing with water the solid surface that is brought into contact with the treatment liquid.

The method for hydrophilizing a solid surface of the present invention may impart anti-fogging properties to the solid surface. That is, the present invention provides an anti-fogging treatment method for a solid surface, wherein a treatment liquid containing component (A), component (B) and water, in which a molar ratio between components (A) and (B), (B)/(A), is 0.01 or more and 10 or less, is brought into contact with the solid surface.

The method for hydrophilizing a solid surface of the present invention may impart antisoiling properties to the solid surface. That is, the present invention provides an antisoiling treatment method for a solid surface, wherein a treatment liquid containing component (A), component (B) and water, in which a molar ratio between components (A) and (B), (B)/(A), is 0.01 or more and 10 or less, is brought into contact with the solid surface.

The method for hydrophilizing a solid surface of the present invention may impart decontaminating properties to the solid surface. That is, the present invention provides a decontaminating treatment method for a solid surface, wherein a treatment liquid containing component (A), component (B) and water, in which a molar ratio between components (A) and (B), (B)/(A), is 0.01 or more and 10 or less, is brought into contact with the solid surface.

The method for hydrophilizing a solid surface of the present invention may impart water absorbency to the solid surface. That is, the present invention provides a method for imparting water absorbency to a solid surface, wherein a treatment liquid containing component (A), component (B) and water, in which a molar ratio between components (A) and (B), (B)/(A), is 0.01 or more and 10 or less, is brought into contact with the solid surface.

The matters mentioned in the hydrophilization treatment agent composition and the method for hydrophilizing a solid surface of the present invention can be appropriately applied to these methods. Further, preferable modes in these compositions, for example, components (A) and (B) and the contents thereof, as well as preferable modes of the treatment liquid, and the like are also the same as in the hydrophilization treatment agent composition and the method for hydrophilizing a solid surface of the present invention.

### [Hydrophilization Detergent Composition]

A hydrophilization detergent composition of the present invention contains an internal olefin sulfonate salt as component (A1). Here, the hydrophilization detergent composition may be a composition that both washes and hydrophilizes an object, for example, a solid surface. An internal olefin sulfonate salt as component (A1) may be an IOS described in the hydrophilization treatment agent composition of the present invention, and specific examples and preferable modes are also the same. The hydrophilization detergent composition of the present invention can wash and hydrophilize a solid surface with a single agent.

The hydrophilization detergent composition of the present invention contains component (A1) in an amount of preferably 0.03 mass % or more, more preferably 0.1 mass % or more, further preferably 0.2 mass % or more and furthermore preferably 0.4 mass % or more, and preferably 100 mass % or less, more preferably 50 mass % or less, further preferably 10 mass % or less, furthermore preferably 5 mass % or less, furthermore preferably 2 mass % or less and furthermore preferably 0.8 mass % or less from the viewpoint of improving the washing performance. Note that mass % of component (A1) is based on the amount expressed in terms of a compound in which the anionic group is not neutralized, i.e., an acid-type compound (the same applies hereinafter).

When used, the hydrophilization detergent composition of the present invention is used in a hydrophilization detergent liquid containing component (A1) in an amount of preferably 0.03 mass % or more, more preferably 0.08 mass % or more, further preferably 0.1 mass % or more, furthermore preferably 0.2 mass % or more and furthermore preferably 0.4 mass % or more, and preferably 10 mass % or less, more preferably 5 mass % or less, further preferably 2 mass % or less and furthermore preferably 0.8 mass % or less from the viewpoint of improving the washing performance.

A suitable content of component (A1) in the hydrophilization detergent composition of the present invention when used is the same as that of the content of component (A) in the hydrophilization treatment agent composition from the viewpoint of improving the hydrophilicity of solid surfaces.

The hydrophilization detergent composition of the present invention may be used with component (B).

The hydrophilization detergent composition of the present invention is preferably used by mixing with water containing a hardness component corresponding to component (B) from the viewpoint of improving the washing performance.

The hydrophilization detergent composition of the present invention may be formulated with components (A1) and (B).

Examples of the hydrophilization detergent composition of the present invention include a hydrophilization detergent composition containing component (A1), component (B) and water, wherein component (A1) is contained in an amount of 0.03 mass % or more.

Suitable modes in the hydrophilization detergent composition of the present invention are the same as those in the hydrophilization treatment agent composition from the viewpoint of improving the hydrophilicity of solid surfaces.

In the hydrophilization detergent composition of the present invention, a molar ratio between components (A1) and (B), (B)/A1), is preferably 1.7 or less, more preferably 0.5 or less and further preferably 0.3 or less from the viewpoint of improving the washing performance.

In addition, in the hydrophilization detergent composition of the present invention, from the viewpoint of improving the hydrophilicity of solid surfaces, a suitable range for the molar ratio between components (A1) and (B), (B)/(A1), is the same as that for the molar ratio between components (A) and (B), (B)/(A), in the hydrophilization treatment agent.

The hydrophilization detergent composition of the present invention can contain the same optional components as in the hydrophilization treatment agent.

The hydrophilization detergent composition of the present invention preferably contains water. Water is usually the balance of a composition and is contained in such an amount as to make the total 100 mass %. The hydrophilization detergent composition of the present invention is preferably a liquid composition.

The hydrophilization detergent composition of the present invention may be a hydrophilization detergent composed of (A1) an internal olefin sulfonate salt and water.

Suitable ranges for the pH and viscosity of the hydrophilization detergent composition of the present invention at 20° C. is the same as those for the pH and viscosity of the hydrophilization treatment agent at 20° C.

Solid surfaces to which the hydrophilization detergent composition of the present invention is directed may be the same as those described in the hydrophilization treatment agent composition of the present invention.

The present invention includes use, as a hydrophilization detergent composition, of a composition containing component (A1), and further a composition containing components (A1) and (B). The compositions preferably contain water. The matters mentioned in the hydrophilization detergent composition of the present invention can be appropriately applied to these uses. For example, in these uses, preferable modes such as specific examples or the contents in the compositions of components (A1) and (B), or the like are the same as in the hydrophilization detergent composition of the present invention.

### [Method for Hydrophilizing and Washing Solid Surface]

The present invention relates to a method for hydrophilizing and washing a solid surface including the following step 1:

### <Step 1>

a step of bringing hydrophilization detergent liquid (I) containing (A1) an internal olefin sulfonate salt in an amount of 0.03 mass % or more into contact with the solid surface.

The step 1 may be a step of washing the solid surface.

Component (A1) and the solid surface are the same as those mentioned in the hydrophilization detergent composition of the present invention. The matters mentioned in the hydrophilization treatment agent composition of the present invention can be appropriately applied to the method for hydrophilizing and washing a solid surface of the present invention. For example, in the method for hydrophilizing and washing a solid surface of the present invention, preferable modes such as specific examples or the content in the hydrophilization detergent liquid of component (A1), or the like are the same as in the hydrophilization detergent composition of the present invention (provided that the hydrophilization detergent composition is read as the hydrophilization detergent liquid as necessary).

Hydrophilization detergent liquid (I) used in the present invention may be the hydrophilization detergent composition of the present invention or may be obtained by mixing the hydrophilization detergent composition of the present invention and water.

In the method for hydrophilizing and washing a solid surface of the present invention, the solid surface is preferably a solid surface of a hard article.

Hydrophilization detergent liquid (I) is a liquid composition containing water and preferably an aqueous solution or an aqueous dispersion from the viewpoint of stability in handling.

Hydrophilization detergent liquid (I) that is brought into contact with the solid surface contains component (A1) in an amount of 0.03 mass % or more from the viewpoint of improving the washing performance. Hydrophilization detergent liquid (I) contains component (A1) in an amount of preferably 0.05 mass % or more, more preferably 0.1 mass % or more, further preferably 0.2 mass % or more, furthermore preferably 0.3 mass % or more and furthermore preferably 0.4 mass % or more, and preferably 10 mass % or less, more preferably 5 mass % or less, further preferably 3 mass % or less, furthermore preferably 2 mass % or less, furthermore preferably 1 mass % or less and furthermore preferably 0.8 mass % or less.

A suitable range for the content of component (A1) in hydrophilization detergent liquid (I) that is brought into contact with the solid surface is the same as that for the content of component (A) in the hydrophilization treatment liquid that is brought into contact with the solid surface from the viewpoint of improving the hydrophilicity of the solid surface.

When the hydrophilization detergent composition of the present invention contains component (A1) in the aforementioned range, it can be used as-is as hydrophilization detergent liquid (I).

The period of time during which hydrophilization detergent liquid (I) is brought into contact with the solid surface in step 1 is preferably 1 minute or more, more preferably 2 minutes or more and further preferably 3 minutes or more from the viewpoint of developing the washing performance of the hydrophilization detergent liquid, and preferably 10 minutes or less, more preferably 8 minutes or less and further preferably 7 minutes or less from the same viewpoint.

A suitable range for the temperature of hydrophilization detergent liquid (I) that is brought into contact with the solid surface in step 1 is the same as that for the temperature of the hydrophilization treatment agent in the hydrophilization treatment method.

In the hydrophilizing and washing method of the present invention, the solid surface may be rinsed with water after hydrophilization detergent liquid (I) is brought into contact with the solid surface in step 1. That is, the hydrophilizing and washing method of the present invention can include a step of rinsing the solid surface with water after the aforementioned step 1. Water with the same hardness as the water used for preparing hydrophilization detergent liquid (I) is preferably used for rinsing. For example, water with a hardness of 4° dH or more and 100° dH or less can be used for rinsing.

A method for bringing hydrophilization detergent liquid (I) into contact with the solid surface is not particularly limited. Examples thereof include, for example, the following methods (i) to (ii) and the like:

(i-1) a method of immersing the solid in hydrophilization detergent liquid (I); and optionally, (i-2) a method of further washing the solid using external force such as mechanical force or the like after (i-1); and

(ii) a method of spraying or applying hydrophilization detergent liquid (I) onto the solid surface.

In the method (i-1), a suitable range for an immersion time period is the same as in the case of the method for bringing the hydrophilization treatment liquid into contact with the solid surface from the viewpoint of enhancing the hydrophilization performance and washing performance of hydrophilization detergent liquid (I) and the viewpoint of improving productivity.

In the method (i-2), hydrophilization detergent liquid (I) is preferably used or brought into contact with the solid surface in the form of a detergent composition containing components (A1) and (B) of the present invention. A suitable range for the pH in the form of such a detergent composition is the same as in the case where the hydrophilization treatment liquid is used in the form of a detergent composition. The detergent composition can optionally contain another surfactant or the like. The step of washing the solid using external force can be performed by washing with a washing machine, rubbing and washing using a sponge or the like, etc.

In the method (ii), a method for spraying or applying hydrophilization detergent liquid (I) onto the solid surfaces is the same as the method for spraying or applying the hydrophilization treatment liquid onto the solid surface.

The content of component (A1) in hydrophilization detergent liquid (I) may be adjusted depending on the hardness of hydrophilization detergent liquid (I) and the material of the solid surface.

For example, when the hardness of hydrophilization detergent liquid (I) is 10° dH or more and 30° dH or less and the material of the solid surface is plastic, especially a polyolefin such as polyethylene or polypropylene, or glass, hydrophilization detergent liquid (I) contains component (A1) in an amount of 0.03 mass % or more, preferably 0.05 mass % or more, more preferably 0.1 mass % or more and further preferably 1 mass % or more, and preferably 10 mass % or less, more preferably 5 mass % or less and further preferably 2 mass % or less from the viewpoint of improving the detergency.

Further, for example, when the hardness of hydrophilization detergent liquid (I) is 2° dH or more and less than 10° dH and the material of the solid surface is plastic, especially a polyolefin such as polyethylene or polypropylene, or glass, hydrophilization detergent liquid (I) contains component (A1) in an amount of 0.03 mass % or more, preferably 0.05 mass % or more, more preferably 0.5 mass % or more and further preferably 0.1 mass % or more, and preferably 10 mass % or less, more preferably 5 mass % or less and further preferably 2 mass % or less from the viewpoint of improving the detergency.

The hydrophilizing and washing method of the present invention preferably includes the following step 2 after the aforementioned step 1:

### <Step 2>

a step of bringing, into contact with the solid surface, hydrophilization detergent liquid (II) containing (A1) an internal olefin sulfonate salt [hereinafter, referred to as component (A1)] and (B) a polyvalent metal ion [hereinafter, referred to as component (B)], wherein the content of component (A1) is 0.03 mass %, or more.

In hydrophilization detergent liquid (II), component (A1), component (B) and the solid surface are also the same as mentioned in the hydrophilization detergent composition of the present invention. The matters mentioned in the hydrophilization detergent composition of the present invention can also be appropriately applied to hydrophilization detergent liquid (II). Hydrophilization detergent liquid (II) used in the present invention may be the hydrophilization detergent composition of the present invention or may be obtained by mixing the hydrophilization detergent composition of the present invention and water. In the hydrophilizing and washing method of the present invention, component (B) is preferably a divalent metal ion.

It has been found that component (A1) develops a more excellent hydrophilizing effect under coexistence with component (B). Therefore, in the present invention, it is preferable to perform not only step 1 but also step 2 for obtaining such an excellent effect by both washing and hydrophilization. For example, if, after the solid surface is washed with a hydrophilization treatment agent containing component (A1), component (B) is supplied in the presence of component (A1), more excellent hydrophilicity can be imparted to the said washed solid surface.

The present invention may be a method including: washing a solid surface with a hydrophilization detergent liquid containing component (A1) and a hardness component at predetermined concentrations; and thereafter, supplying water containing the hardness component to the hydrophilization detergent liquid that is in contact with the solid surface to increase the relative amount of the hardness component to component (A1) on the solid surface, thereby hydrophilizing the solid surface.

The aforementioned step 2 may be a step of hydrophilizing the solid surface.

When the content of component (A1) in hydrophilization detergent liquid (II) of step 2 is smaller than the content of component (A1) in hydrophilization detergent liquid (I) of step 1, the aforementioned step 2 may be a step of diluting hydrophilization detergent liquid (I) on the solid surface to reduce the content of component (A1) in the said hydrophilization detergent liquid (I) and allowing components (A1) and (B) to coexist on the hard surface.

In hydrophilization detergent liquid (II), the content of component (A1) is 0.03 mass % or more. In hydrophilization detergent liquid (II), the content of component (A1) is preferably 0.05 mass % or more, more preferably 0.08 mass % or more and further preferably 0.5 mass % or more, and preferably equal to or less than the content of component (A1) in the hydrophilization detergent liquid of step 1 or less than the content of component (A1) in the hydrophilization detergent liquid of step 1 from the viewpoint of improving the hydrophilicity of the solid surface.

In addition, the content of component (A1) in hydrophilization detergent liquid (II) is preferably 90 mass % or less of the content of component (A1) in the hydrophilization detergent liquid of step 1, preferably 70 mass %, or less and further preferably 50 mass %, or less of the content of component (A1) in the hydrophilization detergent liquid of step 1 from the viewpoint of improving the hydrophilicity of the solid surface.

From the viewpoint of improving the hydrophilicity of the solid surface, component (A1) is applied to the solid surface preferably at a slightly lower concentration than the concentration at which washing is performed.

In step 2, water containing polyvalent metal ion (B) is supplied to dilute hydrophilization detergent liquid (I) while hydrophilization detergent liquid (I) is in contact with the solid surface after the completion of step 1, thereby forming and bringing into contact with the solid surface hydrophilization detergent liquid (II) of step 2.

For example, step 2 may be a step of, after step 1, supplying water containing component (B) to hydrophilization detergent liquid (I) used in step 1 in an amount that makes the content of component (A1) in the hydrophilization detergent liquid 0.03 mass % or more. If a state in which the content of component (A1) is in this range can be formed after step 1, the content of component (A1) may be outside the aforementioned range of amounts afterwards. For example, step 2 may be a step of, after step 1, supplying water containing component (B) to the solid surface to form the state in which the content of component (A1) is in the aforementioned range, and thereafter, continuing supplying water containing component (B). However, the case where the content of component (A) is outside the aforementioned range is excluded from step 2.

The content of component (A1) in hydrophilization detergent liquid (II) may be adjusted depending on the hardness of hydrophilization detergent liquid (II) and the material of the solid surface.

For example, when the hardness of hydrophilization detergent liquid (II) is 10° dH or more and 30° dH or less and the material of the solid surface is plastic, especially a polyolefin such as polyethylene or polypropylene, hydrophilization detergent liquid (II) contains component (A1) in an amount of 0.03 mass % or more, preferably 0.05 mass % or more, more preferably 0.1 mass % or more and further preferably 0.5 mass % or more from the viewpoint of improving the hydrophilicity of the solid surface in the case of not performing rinsing.

In addition, for example, when the hardness of hydrophilization detergent liquid (II) is 10° dH or more and 30° dH or less and the material of the solid surface is plastic, especially a polyolefin such as polyethylene or polypropylene, hydrophilization detergent liquid (II) contains component (A1) in an amount of 0.03 mass % or more, preferably 0.05 mass % or more and more preferably 0.5 mass % or more, and preferably 1.5 mass % or less and more preferably 1 mass % or less from the viewpoint of improving the hydrophilicity of the solid surface in the case of performing rinsing.

The period of time during which hydrophilization detergent liquid (II) is brought into contact with the solid surface in step 2 is preferably 1 minute or more and more preferably 2 minutes or more from the viewpoint of developing the washing performance of the hydrophilization detergent liquid, and preferably 10 minutes or less and more preferably 5 minutes or less from the same viewpoint.

A suitable range for the period of time during which hydrophilization detergent liquid (II) is brought into contact with the solid surface in step 2 is the same as that for the period of time during which the hydrophilization treatment liquid is brought into contact with the solid surface in the hydrophilizing method from the viewpoint of improving the hydrophilicity of the solid surface.

A suitable range for the temperature of hydrophilization detergent liquid (II) that is brought into contact with the solid surface in step 2 is the same as that for the temperature of the hydrophilization treatment liquid that is brought into contact with the solid surface in the aforementioned hydrophilizing method.

When the hydrophilizing and washing method of the present invention includes step 2, it can include a step of rinsing the solid surface with water (hereinafter, referred to as a rinsing step) after the aforementioned step 1 and/or step 2. For example, the hydrophilizing and washing method of the present invention may include the rinsing step after the aforementioned step 1 and not include the rinsing step after the aforementioned step 2.

With respect to the aforementioned embodiments, the present invention further discloses the following hydrophilization treatment agent compositions, methods for hydrophilizing solid surfaces, hydrophilization detergent compositions, methods for hydrophilizing and washing solid surfaces, hydrophilization detergents, uses and the like.

<1>

A hydrophilization treatment agent composition comprising (A) a branched-type anionic surfactant [hereinafter, referred to as component (A)], (B) a polyvalent metal ion [hereinafter, referred to as component (B)], and water, wherein a molar ratio between components (A) and (B), (B)/(A), is 0.01 or more and 10 or less.

<2>

The hydrophilization treatment agent composition according to <1>, wherein component (A) is contained in an amount of preferably 0.001 mass % or more, more preferably 0.005 mass % or more and further preferably 0.01 mass % or more, and preferably 60 mass % or less, more preferably 40 mass % or less, further preferably 25 mass % or less, furthermore preferably 10 mass % or less and furthermore preferably 5 mass % or less.

<3>

The hydrophilization treatment agent composition according to <1> or <2>, wherein the composition is for use on hard surfaces.

<4>

The hydrophilization treatment agent composition according to any one of <1> to <3>, wherein component (A) is one or more branched-type anionic surfactants selected from an internal olefin sulfonate salt, an alkylbenzene sulfonate salt, a secondary alkane sulfonate salt and a dialkyl sulfosuccinate salt.

<5>

The hydrophilization treatment agent composition according to any one of <1> to <3>, wherein component (A) is an internal olefin sulfonate salt.

<6>

The hydrophilization treatment agent composition according to <5>, wherein the internal olefin sulfonate salt has 16 or more and further 18 or more, and 24 or less and further 22 or less carbons.

<7>

The hydrophilization treatment agent composition according to <5> or <6>, wherein a salt of the internal olefin sulfonate salt is an alkali metal salt, an alkaline earth metal (½ atom) salt, an ammonium salt or an organic ammonium salt, further an alkaline earth metal salt and further a potassium salt.

<8>

The hydrophilization treatment agent composition according to any one of <1> to <7>, wherein component (B) is a divalent or more and trivalent or less metal ion and further a divalent metal ion.

<9>

The hydrophilization treatment agent composition according to any one of <1> to <8>, wherein component (B) is ions of the group 2 elements and further one or more selected from a calcium (Ca) ion and a magnesium (Mg) ion.

<10>

The hydrophilization treatment agent composition according to any one of <1> to <9>, wherein component (B) includes a Ca ion and further includes Ca and Mg ions.

<11>

The hydrophilization treatment agent composition according to any one of <1> to <10>, wherein component (B) includes Ca and Mg ions and a molar ratio of Ca ion/Mg ion is preferably 5/5 or more and more preferably 7/3 or more, and preferably 9/1 or less.

<12>

The hydrophilization treatment agent composition according to any one of <1> to <11>, wherein a molar ratio between components (A) and (B), (B)/(A), is 0.01 or more, preferably 0.1 or more, more preferably 0.2 or more, further preferably 0.5 or more and further preferably 1 or more, and 10 or less, preferably 5 or less and more preferably 3 or less.

<13>

The hydrophilization treatment agent composition according to any one of <1> to <12>, wherein the composition is an anti-fogging agent composition.

<14>

The hydrophilization treatment agent composition according to any one of <1> to <12>, wherein the composition is an antisoiling treatment agent composition.

<15>

The hydrophilization treatment agent composition according to any one of <1> to <12>, wherein the composition is a decontamination treatment agent composition.

<16>

The hydrophilization treatment agent composition according to any one of <1> to <12>, wherein the composition is a water absorbency imparting agent composition.

<17>

The hydrophilization treatment agent composition according to any one of <1> to <12>, wherein the composition is a hydrophilization detergent composition.

<18>

A method for hydrophilizing a solid surface, wherein a treatment liquid comprising (A) a branched-type anionic surfactant [hereinafter, referred to as component (A)], (B) a polyvalent metal ion [hereinafter, referred to as component (B)], and water, in which a molar ratio between components (A) and (B), (B)/(A), is 0.01 or more and 10 or less, is brought into contact with the solid surface.

<19>

The method for hydrophilizing a solid surface according to <18>, wherein the solid surface is a solid surface of a hard article.

<20>

The method for hydrophilizing a solid surface according to <18> or <19>, wherein the solid surface is rinsed with water after the treatment liquid is brought into contact with the solid surface.

<21>

The method for hydrophilizing a solid surface according to any one of <18> to <20>, wherein the treatment liquid is obtained by mixing the hydrophilization treatment agent composition according to any one of <1> to <17> with water.

<22>

The method for hydrophilizing a solid surface according to any one of <18> to <21>, wherein the treatment liquid is obtained by mixing a composition comprising component (A) and water with a composition comprising component (B) and water.

<23>

The method for hydrophilizing a solid surface according to any one of <18> to <22>, wherein the treatment liquid is brought into contact with the solid surface for preferably 0.1 seconds or more, more preferably 0.5 seconds or more, further preferably 1 second or more and further preferably 60 seconds or more, and preferably 90 minutes or less, more preferably 60 minutes or less and further preferably 30 minutes or less.

<24>

The method for hydrophilizing a solid surface according to any one of <18> to <23>, wherein a temperature of the treatment liquid is preferably 5° C. or more, more preferably 10° C. or more and more preferably 15° C. or more, and preferably 95° C. or less, more preferably 90° C. or less, more preferably 80° C. or less, further preferably 50° C. or less, furthermore preferably 40° C. or less, furthermore preferably 35° C. or less and furthermore preferably 30° C. or less.

<25>

The method for hydrophilizing a solid surface according to any one of <18> to <24>, wherein the treatment liquid is left at 0° C. or more and 80° C. or less for 10 seconds or more and 30 minutes or less after brought into contact with the solid surface.

<26>

The method for hydrophilizing a solid surface according to any one of <18> to <25>, wherein the treatment liquid is brought into contact with the solid surface by any of the following methods (i) to (iii):

(i) a method of immersing the solid in the treatment liquid;

(ii) a method of spraying or applying the treatment liquid onto the solid surface; and

(iii) a method of washing the solid surface with the treatment liquid in accordance with the usual manner.

<27>

An anti-fogging treatment method for a solid surface, wherein a treatment liquid comprising component (A), component (B) and water, in which a molar ratio between components (A) and (B), (B)/(A), is 0.01 or more and 10 or less, is brought into contact with the solid surface.

<28>

An antisoiling treatment method for a solid surface, wherein a treatment liquid comprising component (A), component (B) and water, in which a molar ratio between components (A) and (B), (B)/(A), is 0.01 or more and 10 or less, is brought into contact with the solid surface.

<29>

A decontamination treatment method for a solid surface, wherein a treatment liquid comprising component (A), component (B) and water, in which a molar ratio between components (A) and (B), (B)/(A), is 0.01 or more and 10 or less, is brought into contact with the solid surface.

<30>

A method for imparting water absorbency to a solid surface, wherein a treatment liquid comprising component (A), component (B) and water, in which a molar ratio between components (A) and (B), (B)/(A), is 0.01 or more and 10 or less, is brought into contact with the solid surface.

<31>

A hydrophilization detergent composition comprising (A1) an internal olefin sulfonate salt [hereinafter, referred to as component (A1)].

<32>

The hydrophilization detergent composition according to <31>, wherein component (A1) is contained in an amount of preferably 0.03 mass % or more, more preferably 0.1 mass % or more, further preferably 0.2 mass % or more and furthermore preferably 0.4 mass % or more, and preferably 100 mass % or less, more preferably 50 mass % or less, further preferably 10 mass % or less, furthermore preferably 5 mass % or less, furthermore preferably 2 mass % or less and furthermore preferably 0.8 mass % or less.

<33>

The hydrophilization detergent composition according to <31> or <32>, wherein the composition is used by mixing with water comprising a hardness component.

<34>

The hydrophilization detergent composition according to any one of <31> to <33>, wherein the composition is used in a hydrophilization detergent liquid comprising component (A1) in an amount of 0.03 mass % or more.

<35>

A hydrophilization detergent composition comprising (A1) an internal olefin sulfonate salt [hereinafter, referred to as component (A1)], (B) a polyvalent metal ion [hereinafter, referred to as component (B)], and water, wherein component (A1) is contained in an amount of 0.03 mass % or more.

<36>

The hydrophilization detergent composition according to <35>, wherein component (B) is a divalent metal ion.

<37>

The hydrophilization detergent composition according to any one of <31> to <36>, wherein the composition is for use on hard surfaces.

<38>

A method for hydrophilizing and washing a solid surface comprising the following step 1:

<step 1>

a step of bringing hydrophilization detergent liquid (I) comprising (A1) an internal olefin sulfonate salt in an amount of 0.03 mass % or more into contact with the solid surface.

<39>

The hydrophilizing and washing method according to <38>, wherein step 1 is a step of washing the solid surface.

<40>

The hydrophilizing and washing method according to <38> or <39>, wherein a period of time during which hydrophilization detergent liquid (I) is brought into contact with the solid surface in step 1 is preferably 1 minute or more, more preferably 2 minutes or more and further preferably 3 minutes or more, and preferably 10 minutes or less, more preferably 8 minutes or less and further preferably 7 minutes or less.

<41>

The hydrophilizing and washing method according to any one of <38> to <40>, comprising the following step 2 after step 1:

<step 2>

a step of bringing, into contact with the solid surface, hydrophilization detergent liquid (II) comprising (A1) an internal olefin sulfonate salt [hereinafter, referred to as component (A1)] and (B) a polyvalent metal ion [hereinafter, referred to as component (B)], wherein the content of component (A1) is 0.03 mass % or more.

<42>

The hydrophilizing and washing method according to <41>, wherein step 2 is a step of hydrophilizing the solid surface.

<43>

The hydrophilizing and washing method according to <41> or <42>, wherein hydrophilization detergent liquid (II) is brought into contact with the solid surface for 10 seconds or more in step 2.

<44>

The hydrophilizing and washing method according to any one of <41> to <43>, wherein a temperature of hydrophilization detergent liquid (II) that is brought into contact with the solid surface in step 2 is 5° C. or more and 95° C. or less.

<45>

The hydrophilizing and washing method according to any one of <41> to <44>, wherein, in step 2, water comprising polyvalent metal ion (B) is supplied to dilute hydrophilization detergent liquid (I) while hydrophilization detergent liquid (I) is in contact with the solid surface after the completion of step 1, thereby forming and bringing into contact with the solid surface hydrophilization detergent liquid (II) of step.

<46>

The hydrophilizing and washing method according to any one of <38> to <45>, wherein component (B) is a divalent metal ion.

<47>

A hydrophilization detergent consisting of (A1) an internal olefin sulfonate salt and water.

<48>

Use of the composition according to any one of <1> to <17> and <31> to <37> for hydrophilizing a solid surface.

### EXAMPLES

### [Production Example 1-1] (Production of C₁₈IOS-K)

7,000 g of 1-octadecanol (manufactured by Kao Corporation, KALCOL 8098) and 700 g of γ-alumina (manufactured by Strem Chemicals, Inc.) as a catalyst were prepared in a flask with a stirrer, and the reaction was carried out under stirring at 280° C. with nitrogen (7,000 ml/min.) circulating in the system, thereby obtaining a crude internal olefin. The crude internal olefin was distilled at 148-158° C. and 0.5 mmHg to obtain an internal olefin with 18 carbons with an olefin purity of 100%. The internal olefin was placed in a thin-film sulfonation reactor (inner diameter: 14 mmφ, length: 4 m), and using a sulfur trioxide gas with an SO₃ concentration of 2.8 volume %, the sulfonation reaction was carried out under the condition that cooling water at 20° C. was passed through an outer jacket of the reactor. The reaction molar ratio (SO₃/internal olefin) was set at 1.09.

The resultant sulfonated product was added to a potassium hydroxide aqueous solution equivalent to 1.2 molar times the theoretical acid number, and neutralized at 30° C. for 1 hour with stirring. The neutralized product was hydrolyzed by heating in an autoclave at 160° C. for 1 hour to obtain a crude product of an internal olefin sulfonate potassium salt.

300 g of the crude product and 300 mL of ethanol were placed in a separatory funnel, and 300 mL of petroleum ether was added per time to extract and remove oil-soluble impurities. At this time, components such as sodium sulfate and the like which were precipitated at the oil-water interface due to the addition of ethanol were also separated and removed from the water phase by oil-water separation operation, and this operation was carried out three times. The water phase side was evaporated to dryness to obtain a potassium salt of an internal olefin sulfonate with 18 carbons (C₁₉IOS-K).

The molar mass distribution of positions at which sulfonic acid groups were present in the C₁₈IOS-K was as follows: position 1: 1.6%, position 2: 25.1% and positions 3-9: 73.3%. The molar ratio of an H species to an O species (H species/O species) was 80/20.

### [Production Example 2] (Preparation of Hard Water Stock Solution 1)

Hard water with a hardness of 5000° dH was obtained by mixing 83.32 g of calcium chloride (manufactured by FUJIFILM Wako Pure Chemical Corporation, CaCl₂, Wako grade 1), 36.99 g of magnesium chloride hexahydrate (manufactured by FUJIFILM Wako Pure Chemical Corporation, MgCl₂.6H₂O, Wako grade 1) and deionized water in an amount that makes the solution volume 1 L. The molar ratio of Ca to Mg (Ca/Mg) is 8/2. This hard water with a hardness of 5000° dH was used as hard water for each test by appropriately diluting with deionized water as a stock solution.

### Examination Example 1

Using the following hydrophilization treatment agent compositions, the evaluation of hydrophilization surfacing was conducted in the following manner.

### <Hydrophilization Treatment Agent Compositions>

Inventive product 1: a hydrophilization treatment agent composition obtained by mixing an aqueous solution of C₁₈IOS-K made with deionized water and hard water with a hardness of 16° dH prepared from hard water stock solution 1, wherein the content of C₁₈IOS-K is 0.1 mass % (0.09 mass % when expressed in terms of an acid form) and the molar ratio of (B)/(A) is 1/1

Inventive product 2: a hydrophilization treatment agent composition obtained by mixing an aqueous solution of C₁₈IOS-K made with deionized water and hard water with a hardness of 32° dH prepared from hard water stock solution 1, wherein the content of C₁₈IOS-K is 0.1 mass % (0.09 mass % when expressed in terms of an acid form) and the molar ratio of (B)/(A) is 2/1

Comparative product 1: a hydrophilization treatment agent composition obtained by mixing an aqueous solution of sodium polyoxyethylene (2) dodecyl ether sulfate (AES) with deionized water and hard water with a hardness of 16° dH prepared from hard water stock solution 1, wherein the content of AES is 0.1 mass % (0.094 mass %, when expressed in terms of an acid form) and the molar ratio of (B)/AES is 1/1

### [Test Method (Evaluation of Hydrophilization Surfacing)]

A test piece which was cleaned in advance was immersed in 500 mL of each hydrophilization treatment agent composition contained in a container, and treated at 25° C. and 70 r/min for 15 minutes. Next, as a rinsing step, the liquid in the container was drained and 500 ml of hard water used for preparing the hydrophilization treatment agent composition was added, and the test piece was immersed and rinsed therein at 25° C. and 70 r/min for 1 minute. Then, the rinsing step was performed once again under the same conditions, and the test piece was dried naturally.

The static contact angle relative to deionized water was measured on the treated portion's surface of the test piece using an automatic contact angle meter (manufactured by Kyowa Interface Science Co., Ltd, DM-500) under the conditions of an added amount of the deionized water of 1 μL and 30 seconds after the addition.

The measurement was performed using two test pieces and five times per test piece, and the average value of the ten measurement values was used.

The smaller the contact angle is, the more excellent the hydrophilization performance is. The results are shown in Table 1.

The following test pieces were used.

Glass: a glass plate manufactured by Yugenkaisha Akebono Shokai (four corners were chamfered)

Acrylic: PMMA (black) manufactured by Standard Test Piece, Inc.

Polyamide 66: PA66 manufactured by Standard Test Piece, Inc.

Polycarbonate: polycarbonate (CARBOGLASS polish) manufactured by Standard Test Piece, Inc.

Melamine: melamine manufactured by Standard Test Piece, Inc.

Polyvinyl chloride: PVC manufactured by Engineering Test Service Co., Ltd.

FRP: FRP manufactured by Nippon Testpanel Co., Ltd.

Polyester: PETP manufactured by Engineering Test Service Co., Ltd.

Polystyrene: polystyrene manufactured by Standard Test Piece, Inc.

Polyethylene: PE manufactured by Engineering Test Service Co., Ltd.

ABS: acrylonitrile butadiene styrene (ABS) manufactured by Standard Test Piece, Inc.

Polypropylene: PP manufactured by Engineering Test Service Co., Ltd.

Stainless steel: SUS430 manufactured by Engineering Test Service Co., Ltd.

Aluminum: A1050P (H24) manufactured by Standard Test Piece, Inc.

Aluminum alloy: A3003P (H24) manufactured by Standard Test Piece, Inc.

Automotive steel: SPFC590 manufactured by Standard Test Piece, Inc.

Natural rubber: natural rubber (NR) manufactured by Standard Test Piece, Inc.

Flooring: flooring (plywood) manufactured by Standard Test Piece, Inc.

Carbon material: CFRP (unpolished) manufactured by Standard Test Piece, Inc.

Model skin: BIOSKIN Plate #WHITE manufactured by Beaulax Co., Ltd.

TABLE 1

| | Contact angle (°) | | | |
|---|---|---|---|---|
| | | After treatment | | |
| | | Hydrophilization treatment agent | | |
| | | composition | | |
| | | Comparative | Inventive | Inventive |
| | Before | product 1 | Product 1 | Product 2 |
| Test piece | treatment | ((B)/AES = 1) | ((B)/(A) = 1) | ((B)/(A) = 2) |
| Glass | 29 | 26 | 10 | 10 |
| Acrylic | 68 | 69 | 45 | 9 |
| Polyamide 66 | 77 | 57 | 42 | 10 |
| Polycarbonate | 79 | 72 | 39 | 10 |
| Melamine | 82 | 58 | 35 | 8 |
| Polyvinyl | 85 | 84 | 65 | 11 |
| chloride | | | | |
| FRP | 85 | 73 | 39 | 13 |
| Polyester | 87 | 84 | 15 | 14 |
| Polystyrene | 89 | 86 | 9 | 9 |
| Polyethylene | 93 | 91 | 85 | 10 |
| ABS | 97 | 68 | 38 | 11 |
| Polypropylene | 104 | 99 | 89 | 17 |
| Stainless steel | 78 | 85 | 17 | 17 |
| Aluminum | 92 | 93 | 75 | 13 |
| Aluminum alloy | 79 | 89 | 72 | 17 |
| Automotive | 81 | 44 | 18 | 21 |
| steel | | | | |
| Natural rubber | 109 | 94 | 12 | 12 |
| Flooring | 74 | 62 | 12 | 10 |
| Carbon material | 84 | 83 | 48 | 14 |
| Model skin | 108 | 98 | 95 | 46 |

In Table 1, both (B)/AES and (B)/(A) are molar ratios.

### Examination Example 2a

The evaluation of surface hydrophilization on test pieces was conducted in the same manner as in Examination Example 1, using hydrophilization treatment agent compositions in which the molar ratio of (B)/(A) in inventive product 1 in Examination Example 1 was changed into those shown in Table 2a while the content of C₁₈IOS-K of component (A) remained 0.1 mass %. The results are shown in Table 2. Note that, in Table 2a, a composition with a molar ratio (B)/(A) of 1 corresponds to inventive product 1 in Examination Example 1, and a composition with a molar ratio of the same of 2 corresponds to inventive product 2 in Examination Example 1. In addition, comparative product 2 is as follows.

Comparative product 2: hard water with a hardness of 32° dH prepared from hard water stock solution 1 [the content of component (A) is 0 mass %].

TABLE 2a

| | | Contact angle (°) | | | | | | |
|---|---|---|---|---|---|---|---|---|
| | | (B)/(A) (molar ratio) | | | | | | Comparative |
| Test | Before | in hydrophilization treatment agent composition | | | | | | product 2 |
| piece | treatment | 0.25 | 0.5 | 1 | 2 | 4 | 8 | (only (B)) |
| Glass | 29 | — | 20 | 10 | 10 | 11 | 15 | 44 |
| Polyester | 87 | 77 | 70 | 15 | 14 | 11 | 39 | 79 |
| Polypropylene | 104 | 97 | 91 | 89 | 17 | 49 | 91 | 99 |
| Stainless steel | 78 | 75 | 59 | 17 | 17 | 50 | 77 | 83 |
| Model skin | 108 | — | — | 95 | 46 | 73 | 95 | 105 |

In Table 2a, “-” means not tested.

### Examination Example 2b

The evaluation of surface hydrophilization on test pieces was conducted in the same manner as in Examination Example 2a, provided that components shown in Table 3 were used as component (A) to prepare hydrophilization compositions. The results are shown in Table 2b. Note that the results in Table 2a are also (partially) shown in Table 2b.

TABLE 2b

| | | Contact angle (°) | | | | | | | | | |
|---|---|---|---|---|---|---|---|---|---|---|---|
| | | Component (A) | | | | | | | | | |
| | | C₁₈IOS-K | | C₁₈IOS-Na | | C₁₆IOS-K | | SAS | | DASS | |
| (B)/(A) (molar ratio) | | 1 | 2 | 1 | 2 | 1 | 2 | 1 | 2 | 1 | 2 |
| in hydrophilization treatment | | | | | | | | | | | |
| agent composition | | | | | | | | | | | |
| Test piece | Glass | 10 | 10 | 12 | 9 | 37 | 39 | 27 | 24 | 34 | 30 |
| | Polyester | 15 | 14 | 12 | 16 | 74 | 75 | 79 | 81 | 82 | 74 |
| | Polypropylene | 89 | 17 | 95 | 18 | 89 | 81 | 93 | 97 | 301 | 96 |
| | Stainless steel | 17 | 17 | 19 | 20 | 68 | 64 | 45 | 50 | 74 | 51 |
| | Model skin | 95 | 46 | 98 | 43 | 102 | 93 | 84 | 79 | 71 | 77 |

Components in Table 2b are as follows.

C₁₈IOS-K: the potassium salt of an internal olefin sulfonate with 18 carbons obtained in Production Example 1-1

C₁₈IOS-Na: a sodium salt of an internal olefin sulfonate with 18 carbons, wherein the molar mass distribution of positions at which the sulfonic acid groups were present and the molar ratio of an H species to an O species (H species/O species) were the same as those in C₁₈IOS-K in Production Example 1-1. This C₁₈IOS-Na can be obtained, for example, by the following Production Example 1-2.

### [Production Example 1-2] (Production of C₁₈IOS-Na)

The sodium salt of an internal olefin sulfonate with 18 carbons (C₁₈IOS-Na) is obtained in the same manner as in Production Example 1-1, except that the sulfonated product was neutralized with a sodium hydroxide aqueous solution instead of the potassium hydroxide aqueous solution.

C₁₆IOS-K: a potassium salt of an internal olefin sulfonate with 16 carbons, wherein the molar mass distribution of positions at which the sulfonic acid groups were present was as follows: position 1: 1.8%, position 2: 21.8% and positions 3-8: 76.4-. In addition, the molar ratio of a hydroxy alkane sulfonate salt (H species) to an olefin sulfonate salt (O species) (H species/O species) was 80/20. This C₁₆IOS-K can be obtained, for example, by the following Production Example 1-3.

### [Production Example 1-3] (Production of C₁₆IOS-K)

The potassium salt of an internal olefin sulfonate with 16 carbons (C₁₆IOS-K) is obtained in the same manner as in Production Example 1-1, except that 1-hexadecanol (manufactured by Kao Corporation, KALCOL 6098) is used instead of 1-octadecanol.

SAS: manufactured by Kao Corporation, LATEMUL PS

DASS: manufactured by Tokyo Chemical Industry Co., Ltd., bis(2-ethylhexyl)sulfosuccinate sodium salt

### Examination Example 3

The contact angle relative to an oil droplet was measured on the glass piece after treated with inventive product 2 or comparative product 1 in Examination Example 1.

A large contact angle relative to an oil droplet is an indicator of a high antisoiling effect in the air.

The contact angle was measured in the same manner as in Examination Example 1, except that, instead of deionized water, rapeseed oil was added dropwise in the same manner as in Examination Example 1 onto the glass piece after treated with inventive product 2 or comparative product 1. Code No. 23-0450-5 manufactured by Sigma-Aldrich was used as the rapeseed oil.

As a result, the contact angle of the rapeseed oil was 45.5° for inventive product 2 and 27.8° for comparative product 1, and it was confirmed that inventive product 2 had higher oil repellency and a more excellent antisoiling property against oily stains.

### Examination Example 4

A recontamination prevention effect on the stainless steel piece after treated with inventive product 2 or comparative product 1 in Examination Example 1 was evaluated.

The stainless steel pieces after treated respectively with inventive product 2 and comparative product 1 in Examination Example 1 were immersed together in 2000 ml of hard water with a hardness of 16° dH in a Tupperware container with a lid; 10 ml of rapeseed oil containing 0.02 mass % of sudan III (manufactured by FUJIFILM Wako Pure Chemical Corporation) was added thereto; and the container was vigorously shaken for 1 minute and then drained. Thereafter, the condition of the stainless steel pieces was visually observed.

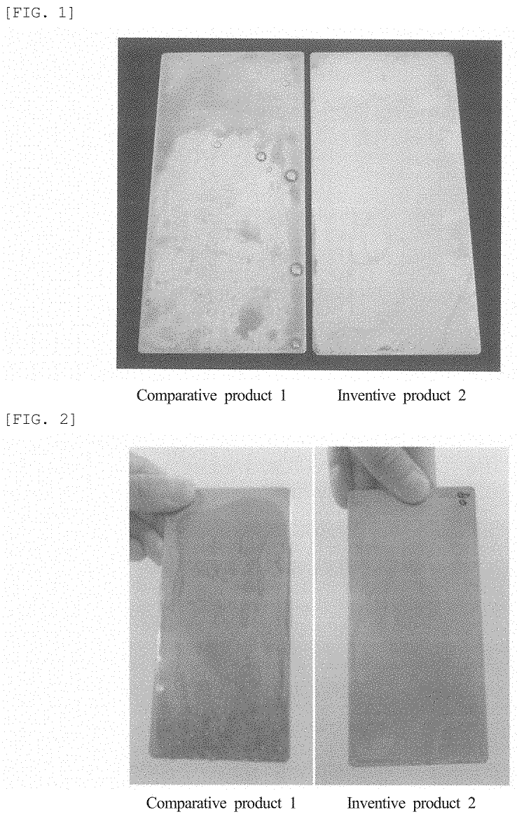

The results are shown in FIG. 1. As shown in FIG. 1, the stainless steel piece treated with inventive product 2 had almost no colored portions remaining on the surface, and it was confirmed that it was not easily recontaminated even if it came in contact with dirt. On the other hand, the stainless steel piece treated with comparative product 1 had colored portions remaining in places on the surface, and it was confirmed that it was susceptible to recontamination.

### Examination Example 5

A decontaminating property of the stainless steel piece after treated with inventive product 2 or comparative product 1 in Examination Example 1 was evaluated.

The stainless steel piece with a size of 15 cm×7 cm was used.

The stainless steel piece after treated with inventive product 2 or comparative product 1 in Examination Example 1 was coated with 3 g of the aforementioned rapeseed oil containing 0.02 mass % of sudan III; and then, deionized water was continuously poured on the piece for 1 minute using a washing bottle; and thereafter, the condition thereof was visually observed.

The results are shown in FIG. 2. As shown in FIG. 2, the stainless steel piece treated with inventive product 2 quickly shed the rapeseed oil and had almost no colored portions remaining on the surface, and it was confirmed that it had an excellent decontaminating property. On the other hand, the stainless steel piece treated with comparative product 1 had residual rapeseed oil and had colored portions remaining in places, and it was confirmed that it was inferior in terms of decontaminating properties.

### Examination Example 6

An anti-fogging property of a wine glass (manufactured by NITORI Co., Ltd., Crystal Red Wine Glass 2P Set (Bordeaux)) after treated with inventive product 2 or comparative product 1 in Examination Example 1 was evaluated.

The wine glass was treated with inventive product 2 or comparative product 1 in Examination Example 1 in the same manner as in Examination Example 1 and dried. The wine glass was filled with 300 g of ice water, and 3 minutes later, the condition of the appearance was visually observed. In addition, a plastic cap with engraved letters was also placed in each wine glass to check its visibility from the outside.

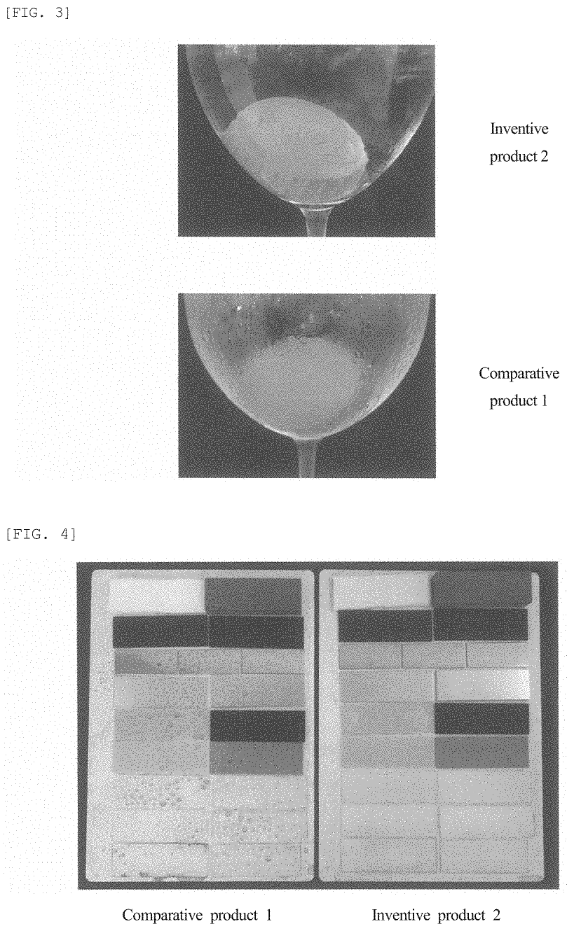

The results are shown in FIG. 3. As shown in FIG. 3, the wine glass treated with inventive product 2 had almost no water droplets adhering thereto, and the plastic cap and its letters could be easily seen through the glass. On the other hand, the wine glass treated with comparative product 1 was so cloudy due to the adhesion of water droplets that the letters on the plastic cap were completely illegible.

### Examination Example 7

Test pieces after each treated with inventive product 2 or comparative product 1 in Examination Example 1 were fixed to a single acrylic board, thereby making a test board. Note that the number of fixed pieces was three for the stainless steel piece. In addition, melamine, FRP and polystyrene were not used in this test. 8 ml of water containing 0.5 mass % of blue dye was sprayed all over the test pieces on the test boards, which were leaned to stand and dried naturally. Thereafter, the condition was visually checked.

The results are shown in FIG. 4. As shown in FIG. 4, the test board treated with inventive product 2 had no water remaining on the test pieces, and it was confirmed that it was not susceptible to water stains. On the other hand, the test board treated with comparative product 1 had water remaining as water droplets all over the test pieces, and it was confirmed that it was in the condition susceptible to water stains.

### Examination Example 8

A fabric strip cut into a rectangle with a long side of 25 cm and a short side of 2.5 cm was subjected to the same hydrophilization treatment as in Examination Example 1 using inventive product 2 and comparative product 1, and dried. A commercially available polyester faille (manufactured by Senshoku Shizai Kabushikikaisha Tanigashira Shoten, 100% polyester) was used as the fabric. On the dried fabric strip, a mark was put with a black water-based marker at a place 2 cm from an end of a short side along the long-side direction. With the place at which the mark was put defined as 0 cm, a mark was put every 1 cm along the long-side direction until a maximum of 20 cm was reached. The fabric strip was placed such that the direction in which the mark of 0 cm was put was down, the opposite short side was up, and the long-side direction was perpendicular to a water surface. Next, a plastic beaker (2 liters in capacity) was filled with 2 L of tap water at 25° C., and a short side (down end) of the fabric strip was immersed in the water until the water surface reached the mark of 0 cm. With the time when the water surface reached 0 cm defined as 0 minutes, the height of the water 15 minutes later was measured. The length from the point of 0 cm to the farthest tip of tips to which the black marks bled and the black ink was developed by chromatography was defined as a water absorption height. A larger numerical value of the water absorption height indicates more favorable water absorbency. The water absorption height of inventive product 2 was 9.4 cm and that of comparative product 1 was 2.1 cm, and it was confirmed that inventive product 2 was more excellent in water absorbency. The above numerical values of the water absorption height are average values for two fabric strips.

### [Internal Olefin Sulfonate Salt 1]

C₁₈IOS-K obtained in Production Example 1-1 was used as internal olefin sulfonate salt 1.

### [Internal Olefin Sulfonate Salt 2]

Internal olefin sulfonate salt 2 was a potassium salt of an internal olefin sulfonate with 16 carbons, wherein the molar mass distribution of positions at which the sulfonic acid groups were present was as follows: position 1: 1.8%, position 2: 21.8% and positions 3-8: 76.4%. In addition, the molar ratio of a hydroxy alkane sulfonate salt (H species) to an olefin sulfonate salt (O species) (H species/O species) was 80/20. This internal olefin sulfonate salt 2 can be obtained, for example, in the same manner as in Production Example 1-3.

### [Production Example 1A] (Production of Internal Olefin Sulfonate Salt 3)

1100 g of an α-olefin with 20-24 carbons (manufactured by Chevron Phillips Chemical Company LP, AlphaPlus C20-24) and 110 g of an activated alumina (manufactured by MIZUSAWA INDUSTRIAL CHEMICALS, LTD., GP-20) as a catalyst were prepared in a flask with a stirrer, and the reaction was carried out under stirring at 280° C. with nitrogen (300 ml/min.) circulating in the system to obtain a crude internal olefin. The crude internal olefin was distilled at 169-212° C. and 0.6 mmHg to obtain an internal olefin with 20-24 carbons with an olefin purity of 100′.

Then, a 1 L four-necked flask was fitted with a mechanical stirrer and two dropping funnels. The inside of the system was decompressed and replaced with nitrogen, and then, 80 g of 1,4-dioxane and 330 g of chloroform were put thereinto and the entire system was cooled in an ice bath. After the cooling, 23 g of liquid SO₃ was added dropwise for 1 hour. After the dropwise addition, 67 g of the internal olefin was added and the reaction was carried out at room temperature.

The resultant sulfonated product was added to a sodium hydroxide aqueous solution equivalent to 1.9 molar times the theoretical acid number, and neutralized at 10° C. for 3 hours with stirring. The neutralized product was placed in a 1 L eggplant flask to remove chloroform, water and dioxane by distillation with an evaporator. Subsequently, the hydrolysis was carried out by heating in an autoclave at 170° C. for 1 hour to obtain a crude product of an internal olefin sulfonate sodium salt.

10 g of the aforementioned crude product of an internal olefin sulfonate sodium salt and 30 mL of ethanol were placed in a separatory funnel, and 30 mL of petroleum ether was added per time to extract and remove oil-soluble impurities. At this time, components such as sodium sulfate and the like precipitated at the oil-water interface due to the addition of ethanol were also separated and removed from the water phase by oil-water separation operation, and this operation was carried out three times. The water phase side was evaporated to dryness to obtain a sodium salt of an internal olefin sulfonate with 20-24 carbons (internal olefin sulfonate salt 3).

### [Production Example 2A] (Preparation of Hard Water Stock Solution 2)

Hard water stock solution 2 with a hardness of 80° dH was obtained by mixing 1.048 g of calcium chloride (manufactured by FUJIFILM Wako Pure Chemical Corporation, CaCl₂, Wako grade 1) and ultrapure water in an amount that makes the solution volume 0.5 L. Note that this hard water stock solution 2 contains Ca²⁺, which is component (B).

### [Production Example 3A] (Preparation of Stock Solution of Internal Olefin Sulfonate Salt)

Stock solutions of internal olefin sulfonate salts 1 to 3 were each prepared by mixing internal olefin sulfonate salts 1 to 3 with ultrapure water so that the concentration was 5 mass %.

### [Production Example 4A] (Preparation of Stock Solution of Comparative Product 4)

As comparative product 4 as a comparative compound of component (A1), sodium α-olefin sulfonate (manufactured by Lion Corporation, LIPOLAN LB-440) was used. A stock solution of comparative product 4 at a concentration of 5 mass % was obtained by mixing the aforementioned sodium α-olefin sulfonate with ultrapure water.

### Example 1

### (Preparation of Test Piece)

### <Alkali Treatment>

A glass slide (manufactured by Matsunami Glass Ind., Ltd., S111, 76 mm×26 mm×0.8-1.0 mm (thickness)) was immersed in a 50 mass % potassium hydroxide aqueous solution at a room temperature of 25° C. for 2 hours. Then, the test piece was rinsed with ultrapure water, thereafter, left to stand for 30 minutes under the conditions of ambient pressure and 60° C., and cooled to room temperature.

### <Test Piece to be Subjected to Hydrophilization Performance Test>

The glass slide after the alkali treatment was used as-is as a test piece to be subjected to hydrophilization performance evaluation (hereinafter, sometimes also referred to as a test piece for a hydrophilization performance test).

### <Test Piece to be Subjected to Washing Test>

The mass (tare mass) of the glass slide after the alkali treatment was measured. After that, the glass slide whose mass was measured was immersed by 2.5 cm into model fat at 60° C. (beef tallow:rapeseed oil=9:1 by mass ratio), left in a room at 25° C. so that the fat solidified, and the mass (mass before washing) was measured. The glass slide with the model fat applied on the surface, which was obtained by the above operation, was used as a test piece to be subjected to washing treatment (hereinafter, sometimes also referred to as a test piece for a washing test).

### (Hydrophilization Detergent Composition and Treatment Liquid)

Hydrophilization detergent compositions and treatment liquids of compositions listed in Table 3 were used. Mass percentages of component (A1) are based on amounts expressed in terms of an acid-type compound (the same applies hereinafter). The compositions were calculated from added amounts of raw materials (the same applies hereinafter). Note that, in Table 3, (total used amount of B)/(total used amount of A1) is the molar ratio of the total amount of B used in first and second steps to the total amount of A1 used in first and second steps (the same applies hereinafter).

### (Evaluation Method)

### <Hydrophilization Performance Evaluation>

After hydrophilization treatments by methods in the following Examples 1-1 to 1-3, the static contact angle relative to ultrapure water was measured on surfaces of treated portions of test pieces using an automatic contact angle meter (manufactured by KRÜSS GmbH, DSA30). The contact angle was measured 5 minutes after 3 μL of ultrapure water was added. In addition, the contact angle was measured at three places per test piece, and the average value was used. The smaller the contact angle is, the more excellent the hydrophilization performance is.

### <Detergency Evaluation>

The mass (mass after washing) of test pieces dried after subjected to washing treatments by methods in the following Examples 1-1 to 1-3 was measured to determine washing rates by the following formula.

Washing rate (%)={(mass before washing)−(mass after washing)}/{(mass before washing)−(tare mass)}×100

The higher the washing rate is, the more excellent the detergency is.

The following treatments were performed using the aforementioned hydrophilization detergent compositions and treatment liquids, as well as the aforementioned test pieces. The results are shown in Table 3.

### Example 1-1

### (Hydrophilization Treatment)

### Step 1

The test piece for hydrophilization performance evaluation was immersed in 40 mL of each hydrophilization detergent composition contained in a 50 mL glass beaker, and treated at 25° C. and 600 rpm for 5 minutes. The hydrophilization detergent composition was stirred using a rotator (manufactured by AS ONE CORPORATION, Laboran rotator (PTFE) 9-870-02) and an electromagnetic stirrer (manufactured by Thermo Fisher Scientific K.K., Cimarec i Telesystem 60 Position).

### Step 2

After step 1, the test piece and a whole amount of the hydrophilization detergent composition were added to a 500 mL beaker containing 360 mL of hard water with a hardness of 20° dH, which was prepared from hard water stock solution 2 and ultrapure water, and further treated at 25° C. and 600 rpm for 5 minutes. Note that the mixture used in step 2 is denoted as a treatment liquid in the table (the same applies hereinafter). The mixture used in this step was stirred using the same rotator and electromagnetic stirrer as described above. The test piece was removed and dried at 25° C. for 24 hours (hereinafter, also referred to as natural drying).

### (Washing Treatment)

The same treatment as the hydrophilization treatment was performed, except that, instead of immersing the test piece for hydrophilization performance evaluation, the portion of the test piece for a washing test coated with the model fat was immersed.

### Example 1-2

### (Hydrophilization Treatment)

### Step 1

The same operations as in Example 1-1 were performed, except that 80 mL of each hydrophilization detergent composition contained in a 100 mL glass beaker was used.

### Step 2

After step 1, the test piece was removed, and the portion of the test piece to which the model fat adhered was all immersed in 80 mL of hard water with a hardness of 20° dH contained in another 100 mL glass beaker, which was prepared from hard water stock solution 2 and ultrapure water, and treated at 25° C. and 600 rpm for 5 minutes.

Note that the mixture used in this step was stirred using the same rotator and electromagnetic stirrer as described above.

### (Washing Treatment)

The same treatment as the hydrophilization treatment was performed, except that, instead of immersing the test piece for hydrophilization performance evaluation, the portion of the test piece for a washing test coated with the model fat was immersed.

Note that, in Example 1-2, as well as the following Examples 1-3, 2-1, 2-2 and 9, the composition containing component (A1) adheres to the test piece at the completion of step 1, but the amount of component (A1) to be incorporated into hard water from the adhered composition in step 2 is extremely small, so that the amount is not included in the content of component (A1) in step 2.

### Example 1-3

Hydrophilization treatment and washing treatment were performed under the same conditions as in Example 1-2, except that a treatment liquid listed in Table 3 was used in step 2.

TABLE 3

| | | | | Example | | |
|---|---|---|---|---|---|---|
| | | | | 1-1 | 1-2 | 1-3 |
| Step 1 | Hydrophilization | Component | Type | Internal olefin sulfonate salt 1 | | |
| | detergent | (Al) | Content | 0.8 | 2 | 2 |
| | composition | | [mass %] | | | |
| | | Hardness [°dH] | | 20 | 20 | 20 |
| | | (B)/(A1) (molar ratio) | | 0.16 | 0.07 | 0.07 |
| Step 2 | Treatment | Component | Type | Internal olefin sulfonate salt 1 | | |
| | liquid | (A1) | Content | 0.08 | 0 | 0.08 |
| | | | [mass %] | | | |

| | | | |
|---|---|---|---|
| Hardness [°dH] | 20 | 20 | 20 |
| (B)/(A1) (molar ratio) | 1.6 | — | 0.2 |

| (Total used amount of B)/(total used amount of A1) | 0.30 | 0.13 | 0.13 |
|---|---|---|---|
| (molar ratio) | | | |
| Test piece | Glass side | | |
| Contact angle [°] | 13.8 | 11.8 | 11.1 |
| Washing rate [%] | 34.3 | 72.9 | 82.3 |

### Example 2

The evaluations were performed under the same conditions as in Examples 1-2, except that hydrophilization detergent compositions and treatment liquids listed in Table 4 were used. The results are shown in Table 4.

TABLE 4

| | | | | Example | |
|---|---|---|---|---|---|
| | | | | 2-1 | 2-2 |
| Step | Hydro- | Component | Type | Internal olefin | |
| 1 | philization | (A1) | | sulfonate salt I | |
| | detergent | | Content | 0.4 | 0.4 |
| | composition | | [mass %] | | |
| | | Hardness [° dH] | | 20 | 20 |
| | | (B)/(A1) (molar ratio) | | 0.33 | 0.33 |
| Step | Treatment | Component | Type | Internal olefin | |
| 2 | liquid | (A1) | | sulfonate salt I | |
| | | | Content | 0 | 0.03 |
| | | | [mass %] | | |

| | | |
|---|---|---|
| Hardness [° dH] | 20 | 20 |
| (B)/(A1) (molar ratio) | — | 4.4 |

| (Total used amount of B)/ | 0.65 | 0.65 |
|---|---|---|
| (total used amount of A1) | | |
| (molar ratio) | | |
| Test piece | Glass slide | |
| Contact angle [°] | 32.4 | 24.8 |
| Washing rate [%] | 42 | 40 |

### Example 3 and Comparative Example 3

### (Preparation of Test Piece)

A test piece to be subjected to a washing test was obtained by the same method as the test piece to be subjected to washing treatment in Example 1, except that a polypropylene substrate (manufactured by Nippon Testpanel Co., Ltd., standard test plate PP) (hereinafter, sometimes also referred to as a PP substrate) was used instead of the glass slide after the alkali treatment.

### (Hydrophilization Detergent Composition)

Hydrophilization detergent compositions of compositions listed in Table 5 were used.

### (Evaluation Method)

Using the test piece dried after subjected to washing treatment by the following method, the washing rate was determined by the same method as in the detergency evaluation described in Example 1. The results are shown in Table 5.

### (Washing Treatment)

### <Without Rinsing>

The entire test piece was immersed in 80 mL of each hydrophilization detergent composition contained in a 100 mL glass beaker, and treated at 25° C. and 600 rpm for 10 minutes. This treatment was performed using the same rotator and electromagnetic stirrer as in Example 1. The test piece was dried naturally after removed.

### <With Rinsing>

The test piece was treated in the same manner as in the case without rinsing, except that, after the test piece was removed and before it was dried naturally, the back and front of the test piece were rinsed with ultrapure water for 3 seconds each using a washing bottle.

TABLE 5

| | | | | | | | | | | Comparative | | | |
|---|---|---|---|---|---|---|---|---|---|---|---|---|---|
| Example | | | | | | | | | | example | | | |
| 3-1 | 3-2 | 3-3 | 3-4 | 3-5 | 3-6 | 3-7 | 3-8 | 3-9 | 3-10 | 3-1 | 3-2 | 3-3 | 3-4 |

Hydrophilization detergent compostion

| Component | Type | Internal olefin | | | | | | | | | | — | — | — | Comparative |
|---|---|---|---|---|---|---|---|---|---|---|---|---|---|---|---|
| (A1) | | sulfonate | | | | | | | | | | | | | product 4 |
| or | | salt 1 | | | | | | | | | | | | | |
| comparative | | | | | | | | | | | | | | | |
| product | Content | 0.03 | 0.08 | 0.4 | 0.8 | 2 | 0.03 | 0.08 | 0.4 | 0.8 | 2 | 0 | 0 | 0 | 0.4 |
| | [mass %] | | | | | | | | | | | | | | |
| Hardness [°dH] | | 20 | | | | | 5 | | | | | 0 | 5 | 20 | 20 |
| (B)/(A1) (molar ratio) | | 4.4 | 1.6 | 0.33 | 0.16 | 0.07 | 1.1 | 0.41 | 0.08 | 0.04 | 0.02 | — | — | — | — |
| Test piece | | Polypropylene substrate | | | | | | | | | | | | | |
| Washing | With | 10.0 | 12.8 | 20.5 | 17.8 | 30.1 | 26.3 | 29.3 | 41 | 11.1 | 24 | 10.4 | 6.8 | 10.4 | 13.1 |
| rate [%] | rinsing | | | | | | | | | | | | | | |
| | Without | — | — | — | 21.0 | 23.1 | — | — | — | — | — | 9.6 | 7 | 6.9 | — |
| | rinsing | | | | | | | | | | | | | | |

### Example 4 and Comparative Example 4

Washing treatment and detergency evaluation were performed in the same manner as in Example 3, except that a test piece obtained by the same method as the test piece to be subjected to washing treatment in Example 1 was used as a test piece and hydrophilization treatment agent compositions of compositions listed in Table 6 were used as hydrophilization detergent compositions. The results are shown in Table 6.

TABLE 6

| | | | | | | | | | | | | Comparative | | | |
|---|---|---|---|---|---|---|---|---|---|---|---|---|---|---|---|
| Example | | | | | | | | | | | | example | | | |
| 4-1 | 4-2 | 4-3 | 4-4 | 4-5 | 4-6 | 4-7 | 4-8 | 4-9 | 4-10 | 4-11 | 4-12 | 4-1 | 4-2 | 4-3 | 4-4 |

Hydrophilization detergent compostion

| Component | Type | Internal olefin sulfonate salt 1 | | | | | | | | | | Internal | Internal | — | — | — | Com |
|---|---|---|---|---|---|---|---|---|---|---|---|---|---|---|---|---|---|
| (A1) | | | | | | | | | | | | olefin | olefin | | | | parative |
| or | | | | | | | | | | | | sulfonate | sulfonate | | | | product |
| com- | | | | | | | | | | | | salt 3 | salt 2 | | | | 4 |
| parative | Content | 0.03 | 0.08 | 0.4 | 0.8 | 2 | 0.03 | 0.08 | 0.4 | 0.8 | 2 | 0.4 | 0.4 | 0 | 0 | 0 | 0.4 |
| product | [mass %] | | | | | | | | | | | | | | | | |
| Hardness [°dH] | | 20 | | | | | 5 | | | | | 5 | 20 | 0 | 5 | 20 | 20 |
| (B)/(A1) | | 4.4 | 1.6 | 0.33 | 0.16 | 0.07 | 1.1 | 0.41 | 0.08 | 0.04 | 0.02 | 0.08 | 0.35 | — | — | — | — |
| (molar ratio) | | | | | | | | | | | | | | | | | |
| Test piece | | Glass slide | | | | | | | | | | | | | | | |
| Washing | With | 13.8 | 31.1 | 63.3 | 75.2 | 85.3 | 21.3 | 50.8 | 70.6 | 51 | 46.1 | 27.6 | 47.5 | 10.4 | 7.6 | 10.4 | 31.9 |
| rate [%] | rinsing | | | | | | | | | | | | | | | | |
| | Without | — | — | — | 20.9 | 20.6 | 7.7 | 6 | 52.8 | 14.6 | 18.6 | — | — | 3.9 | 3.4 | 12.8 | — |
| | rinsing | | | | | | | | | | | | | | | | |

### Example 5 and Comparative Example 5

### (Preparation of Test Piece)

The PP substrate was cleaned with ethanol to obtain a test piece to be subjected to hydrophilization treatment.

### (Hydrophilization Detergent Composition)

Hydrophilization detergent compositions of compositions listed in Table 7 were used as hydrophilization detergent compositions.

### (Evaluation Method)

After the test piece was subjected to hydrophilization treatment by the following method, the hydrophilization performance was evaluated by the same method as in the hydrophilization performance evaluation described in Example 1. The results are shown in Table 7.

### (Hydrophilization Treatment)

### <Without Rinsing>

The entire test piece was immersed in 80 mL of each hydrophilization detergent composition contained in a 100 mL glass beaker, and treated at 25° C. and 600 rpm for 10 minutes. This treatment was performed using the same rotator and electromagnetic stirrer as in Example 1. The test piece was dried naturally after removed.

### <With Rinsing>

The test piece was treated in the same manner as in the case without rinsing, except that, after the test piece was removed and before it was dried naturally, the back and front of the test piece were rinsed with ultrapure water for 3 seconds each using a washing bottle.

TABLE 7

| | | | | | | | | | | | Comparative | | | |
|---|---|---|---|---|---|---|---|---|---|---|---|---|---|---|
| Example | | | | | | | | | | | example | | | |
| 5-1 | 5-2 | 5-3 | 5-4 | 5-5 | 5-6 | 5-7 | 5-8 | 5-9 | 5-10 | 5-11 | 5-1 | 5-2 | 5-3 | 5-4 |

Hydrophilization detergent composition

| Component | Type | Internal olefin sulfonate salt 1 | | | | | | | | | | | — | — | Comparitive | |
|---|---|---|---|---|---|---|---|---|---|---|---|---|---|---|---|---|
| (A1) or | | | | | | | | | | | | | | | product 4 | |
| comparative | | | | | | | | | | | | | | | | |
| product | | | | | | | | | | | | | | | | |
| | Content | 0.03 | 0.08 | 0.4 | 0.8 | 2 | 0.03 | | | 0.8 | | | 0 | 0 | 0.08 | 0.4 |
| | [mass %] | | | | | | | | | | | | | | | |
| Hardness [°dH] | | 20 | | | | | 15 | 10 | 5 | 15 | 10 | 5 | 20 | 0 | 20 | 20 |
| (B)/(A1) | | 4.4 | 1.6 | 0.33 | 0.16 | 0.07 | 3.3 | 2.2 | 1.1 | 0.12 | 0.08 | 0.04 | — | — | — | — |
| (molar ratio) | | | | | | | | | | | | | | | | |
| Test piece | | Polypropylene substrate | | | | | | | | | | | | | | |
| Contact | Without | 19.5 | 5 or | 5 or | 5 or | 5 or | 16.5 | 56.2 | 67.3 | 5 or | 5 or | 5 or | 84 | 85.3 | 75.4 | 83 |
| Angle [°] | rinsing | | less | less | less | less | | | | less | less | less | | | | |
| | With | — | 11.4 | 16.0 | 5 or | 82.5 | — | — | — | — | — | — | 72.5 | — | 83.6 | 79.9 |
| | rinsing | | | | less | | | | | | | | | | | |

### Example 6 and Comparative Example 6

### (Preparation of Test Piece)

The aforementioned glass slide after the alkali treatment was used as-is as a test piece.

### (Hydrophilization Detergent Composition)

Hydrophilization detergent compositions of compositions listed in Table 8 were used.

### (Evaluation Method)

The hydrophilization performance was evaluated by the same method as in the hydrophilization performance evaluation described in Example 1, except that the amount of ultrapure water added to measure the contact angle was 1.5 μL. Note that hydrophilization treatment was performed under the same conditions as in the case without rinsing in Example 5. The results are shown in Table 8.

TABLE 8

| | | | | | | | | | | | | | Comparative | | |
|---|---|---|---|---|---|---|---|---|---|---|---|---|---|---|---|
| Example | | | | | | | | | | | | | example | | |
| 6-1 | 6-2 | 6-3 | 6-4 | 6-5 | 6-6 | 6-7 | 6-8 | 6-9 | 6-10 | 6-11 | 6-12 | 6-13 | 6-1 | 6-2 | 6-3 |

Hydrophilization detergent composition

| Com- | Type | Internal olefin sulfonate salt 1 | | | | | | | | | | | Internal | Internal | — | Com | |
|---|---|---|---|---|---|---|---|---|---|---|---|---|---|---|---|---|---|
| ponent | | | | | | | | | | | | | olefin | olefin | | parative | |
| (A1) or | | | | | | | | | | | | | sulfonate | sulfonate | | product 4 | |
| com- | | | | | | | | | | | | | salt 3 | salt 2 | | | |
| parative | | | | | | | | | | | | | | | | | |
| product | Content | 0.03 | 0.08 | 0.4 | 0.8 | 2 | 0.03 | | | 0.8 | | | 0.4 | 0.4 | 0 | 0.08 | 0.4 |
| | [mass %] | | | | | | | | | | | | | | | | |
| Hardness [°dH] | | 20 | | | | | 15 | 10 | 5 | 15 | 10 | 5 | 5 | 20 | 20 | 20 | 20 |
| (B)/(A1) | | 4.4 | 1.6 | 0.33 | 0.16 | 0.07 | 1.1 | 0.41 | 0.08 | 0.12 | 0.08 | 0.04 | 0.08 | 0.35 | — | — | — |
| (molar ratio) | | | | | | | | | | | | | | | | | |
| Test piece | | Glass slide | | | | | | | | | | | | | | | |
| Contact | Without | 8.8 | 9.4 | 9.8 | 5 or | 5 or | 12.2 | 9.4 | 5 or | 5 or | 5 or | 5 or | 5 or | 5 or | 35.2 | 36.5 | 33.1 |
| Angle[°] | rinsing | | | | less | less | | | less | less | less | less | less | less | | | |

### Example 7

Hydrophilization treatment and hydrophilization performance evaluation were performed under the same conditions as in Example 5, except that compositions of compositions listed in Table 9 were used as hydrophilization detergent compositions and the period of time during which the test piece was immersed was changed as listed in Table 9. The results are shown in Table 9.

TABLE 9

| Example | | | | |
|---|---|---|---|---|
| 7-1 | 7-2 | 7-3 | 7-4 | 7-5 |

Hydrophilization detergent composition

| Component | Type | Internal olefin sulfonate salt 1 | | | | |
|---|---|---|---|---|---|---|
| (A1) | Content | 0.08 | | | | |
| | [mass %] | | | | | |
| Hardness [°dH] | | 20 | | | | |
| (B)/(A1) (molar ratio) | | 1.6 | | | | |
| Immersion time period [second] | | 5 | 60 | 180 | 300 | 600 |
| Test piece | | Polypropylene substrate | | | | |
| Contact angle [°] | Without | 65.9 | 50.6 | 54.4 | 5 or | 5 or |
| | rinsing | | | | less | less |

### Example 8

Hydrophilization treatment and hydrophilization performance evaluation were performed under the same conditions as in Example 5, except that compositions of compositions listed in Table 10 were used as hydrophilization detergent compositions and the period of time during which the test piece was immersed was changed as listed in Table 10.

The results are shown in Table 10.

TABLE 10

| Example | |
|---|---|
| 8-1 | 8-2 |

| | | | |
|---|---|---|---|
| Hydro- | Component | Type | Internal olefin sulfonate salt I |
| philization | (A1) | Content | 0.3 |
| detergent | | [mass %] | |

| | | |
|---|---|---|
| composition | Hardness [° dH] | 15 |
| | (B)/(A1) (molar ratio) | 3.3 |

| Immersion time period [minute] | | 10 | 30 |
|---|---|---|---|
| Test piece | | Polypropylene substrate | |
| Contact angle | Without | 16.5 | 5 or less |
| [°] | rinsing | | |

### Example 9

Hydrophilization treatment and hydrophilization performance evaluation were performed in the same manner as in Example 2-2, except that compositions of compositions listed in Table 11 were used as hydrophilization detergent compositions and treatment liquids and the period of time during which the test piece was immersed in step 2 was changed as listed in Table 11. The results are shown in Table 11.

TABLE 11

| | | | | Example | | | |
|---|---|---|---|---|---|---|---|
| | | | | 9-1 | 9-2 | 9-3 | 9-4 |
| Step 1 | Hydrophilization | Component | Type | Internal | | | |
| | detergent | (A1) | Content | olefin sulfonate | | | |
| | composition | | [mass %] | salt 1 | | | |
| | | | | 0.4 | | | |
| | | Hardness [°dH] | | 5 | | | |
| | | (B)/(A1) | | 0.08 | | | |
| | | (molar ratio) | | | | | |
| Step 2 | Treatment | Component | Type | Internal | | | |
| | liquid | (A1) | Content | olefin sulfonate | | | |
| | | | [mass %] | salt 1 | | | |
| | | | | 0.03 | | | |
| | | Hardness [°dH] | | 5 | | | |
| | | (B)/(Al) | | 1.1 | | | |
| | | (molar ratio) | | | | | |
| | Immersion time period [second] | | | 5 | 60 | 180 | 300 |
| (Total used amount of B)/(total used amount of Al) | | | | 0.16 | | | |
| (molar ratio) | | | | | | | |
| Test piece | | | | Slide glass | | | |
| | Contact angle [°] | Without | | 15.2 | 5 or | 5 or | 5 or |
| | | rinsing | | | less | less | less |
| | Washing | Without | | 32.8 | 33.1 | 41.6 | 35.8 |
| | rate [%] | rinsing | | | | | |

1: A hydrophilization treatment agent composition comprising (A) a branched-type anionic surfactant, (B) a polyvalent metal ion, and water, wherein a molar ratio between (A) and (B), (B)/(A), is 0.01 or more and 10 or less.

2: The hydrophilization treatment agent composition according to claim 1, wherein (A) is contained in an amount of 0.001 mass % or more and 60 mass % or less.

3: The hydrophilization treatment agent composition according to claim 1, wherein the composition is suitable for use on hard surfaces.

4: The hydrophilization treatment agent composition according to claim 1, wherein (A) is one or more branched-type anionic surfactants selected from the group consisting of an internal olefin sulfonate salt, an alkylbenzene sulfonate salt, a secondary alkane sulfonate salt and a dialkyl sulfosuccinate salt.

5: The hydrophilization treatment agent composition according to claim 1, wherein (B) is a divalent metal ion.

6: A method for hydrophilizing a solid surface, comprising contacting the solid surface with a treatment liquid comprising (A) a branched-type anionic surfactant, (B) a polyvalent metal ion, and water, wherein a molar ratio between (A) and (B), (B)/(A), is 0.01 or more and 10 or less.

7: The method for hydrophilizing a solid surface according to claim 6, wherein the solid surface is a solid surface of a hard article.

8: The method for hydrophilizing a solid surface according to claim 6, further comprising rinsing the solid surface with water after the solid surface is contacted with the treatment liquid.

9. (canceled)

10: The method for hydrophilizing a solid surface according to claim 6, wherein the treatment liquid is obtained by mixing a composition comprising the component (A) and water with a composition comprising the component (B) and water.

11-14. (canceled)

15: A hydrophilization detergent composition comprising (A1) an internal olefin sulfonate salt, (B) a polyvalent metal ion, and water, wherein the component (A1) is contained in an amount of 0.03 mass % or more.

16: The hydrophilization detergent composition according to claim 15, wherein the component (B) is a divalent metal ion.

17: The hydrophilization detergent composition according to claim 15, wherein the composition is suitable for use on hard surfaces.

18-27. (canceled)
